(19) United States
(12) Patent Application Publication
(10) Pub. No.: US 2024/0168399 A1
(43) Pub. Date: May 23, 2024

(54) MANUFACTURING METHOD OF ELECTROSTATIC CHARGE IMAGE DEVELOPING TONER

(71) Applicant: FUJIFILM Business Innovation Corp., Tokyo (JP)

(72) Inventors: Ryutaro KEMBO, Kanagawa (JP); Yoshimasa FUJIHARA, Kanagawa (JP); Shintaro ANNO, Kanagawa (JP); Ryuta NAKANE, Kanagawa (JP)

(73) Assignee: FUJIFILM Business Innovation Corp., Tokyo (JP)

(21) Appl. No.: 18/304,358

(22) Filed: Apr. 21, 2023

(30) Foreign Application Priority Data
Nov. 22, 2022 (JP) 2022-186756

(51) Int. Cl. G03G 9/093

(52) U.S. Cl. CPC G03G 9/09357; G03G 9/09392

(57) ABSTRACT

A manufacturing method of an electrostatic charge image developing toner has first aggregation of aggregating resin particles for a core in a raw material dispersion B for a core at an aggregation temperature equal to or lower than a glass transition temperature Tg of the resin particles for a core to form aggregated core particles, the raw material dispersion B for a core being obtained by adding an ionic compound having a monovalent cation to a raw material dispersion A for a core, that contains the resin particles for a core having a glass transition temperature lower than 40° C. and having an ester structure, a nonionic surfactant, and an aqueous medium, second aggregation of mixing an aggregated core particle dispersion containing the aggregated core particles and the aqueous medium with a resin particle dispersion for a shell containing resin particles for a shell having an ester structure and an aqueous medium, and aggregating the resin particles for a shell with the resin particles for a core in a mixed dispersion containing the aggregated core particles and the resin particles for a shell at an aggregation temperature equal to or lower than a glass transition temperature Tg of the resin particles for a shell to form aggregated core particles with a shell, and coalescence of coalescing the aggregated core particles with a shell at a coalescence temperature that is equal to or higher than the glass transition temperatures of the resin particles for a core and the resin particles for a shell and lower than a cloud point of the nonionic surfactant.

### CROSS-REFERENCE TO RELATED APPLICATIONS

This application is based on and claims priority under 35 USC 119 from Japanese Patent Application No. 2022-186756 filed Nov. 22, 2022.

### BACKGROUND

### (i) Technical Field

The present invention relates to a manufacturing method of an electrostatic charge image developing toner.

### (ii) Related Art

For example, JP2011-99954A discloses “an electrostatic latent image developing toner having a core/shell structure, in which a core portion contains at least a hydrophobic resin having a glass transition temperature (Tg) of 10° C. to 30° C., a hydrophilic resin having a glass transition temperature (Tg) of 40° C. to 50° C., and a colorant, the central part of the core portion is rich in a hydrophobic resin having low Tg, the proportion of a hydrophilic resin having high Tg increases toward the outside from the center, and the shell portion consists of a hydrophilic resin having Tg of 50° C. to 70° C.”.

JP6018684B discloses “an electrostatic charge image developing toner and a manufacturing method thereof, the electrostatic charge image developing toner having a core portion that contains a binder resin containing a composite resin (A) and a crystalline polyester (B) and a wax and a shell portion that contains a binder resin containing a polyester resin (C), in which the composite resin (A) is a composite resin that contains a segment (a1) consisting of a polyester resin obtained by polycondensation of an alcohol component containing 80 mol % or more of a propylene oxide adduct of bisphenol A and a polyvalent carboxylic acid component and a vinyl-based resin segment (a2) containing a constitutional unit derived from a styrene-based compound, the crystalline polyester (B) is a crystalline polyester that is obtained by polycondensation of an alcohol component containing 80 mol % or more of an α,ω-aliphatic diol having 8 or more and 16 or less carbon atoms and a polyvalent carboxylic acid component containing 80 mol % or more of an aliphatic saturated dicarboxylic acid having 8 or more and 16 or less carbon atoms, and the polyester resin (C) is a polyester resin that is obtained by polycondensation of an alcohol component containing 80 mol % or more of an ethylene oxide adduct of bisphenol A and a polyvalent carboxylic acid component”.

JP1994-95422A discloses “a manufacturing method of a toner composition, in which the manufacturing method includes steps of (i) stirring a mixture of a nonionic surfactant, an anionic surfactant, a non-polar olephinic first monomer, a non-polar diolephinic second monomer, a free radical initiator, and a chain transfer agent in water to prepare a latex emulsion; (ii) heating the latex emulsion at a temperature of room temperature to about 80° C. to polymerize the emulsion and form non-polar olefinic emulsion-polymerized resin particles having a volume-average particle size of about 5 to about 500 nm; (iii) diluting the non-polar olefinic emulsion-polymerized resin particle mixture with water; (iv) adding colorant or pigment particles to the diluted non-polar olefinic emulsion-polymerized resin particle mixture and, as necessary, dispersing the generated mixture with a homogenizer; (v) adding a cationic surfactant to cause the colorant or pigment particles to be aggregated on the surface of the emulsion-polymerized resin particles; (vi) homogenizing the aggregated mixture under high shear to form electrostatically combined aggregated composite particles having a volume-average particle size of about 5 μm or less; (vii) heating the electrostatically combined aggregated composite particles to form non-polar toner-sized particles; (viii) optionally halogenating the electrostatically combined non-polar toner-sized particles to form non-polar toner-sized particles having an outer surface, that is, capsule shell consisting of a halogenated polymer resin; and (ix) separating the generated non-polar toner-sized particles”.

### SUMMARY

Aspects of non-limiting embodiments of the present disclosure relate to a manufacturing method of an electrostatic charge image developing toner that includes first aggregation of aggregating resin particles for a core in a raw material dispersion B for a core to form aggregated core particles, the raw material dispersion B for a core being obtained by adding an ionic compound having a monovalent cation to a raw material dispersion A for a core, that contains the resin particles for a core having a glass transition temperature lower than 40° C. and having an ester structure, a nonionic surfactant, and an aqueous medium, second aggregation of mixing an aggregated core particle dispersion containing the aggregated core particles and the aqueous medium with a resin particle dispersion for a shell containing resin particles for a shell having an ester structure and an aqueous medium and aggregating the resin particles for a shell with the resin particles for a core in a mixed dispersion containing the aggregated core particles and the resin particles for a shell at an aggregation temperature equal to or lower than a glass transition temperature Tg of the resin particles for a shell to form aggregated core particles with a shell, and coalescence of coalescing the aggregated core particles with a shell at a coalescence temperature that is equal to or higher than the glass transition temperatures of the resin particles for a core and the resin particles for a shell and lower than a cloud point of the nonionic surfactant, the manufacturing method of an electrostatic charge image developing toner being more likely to manufacturing an electrostatic charge image developing toner further suppressing gloss unevenness compared to a manufacturing method of an electrostatic charge image developing toner in which an aggregation temperature in the first aggregation is higher than the glass transition temperature Tg of the resin particles for a core, the aggregation temperature in the second aggregation is higher than the glass transition temperature Tg of the resin particles for a shell, or the aggregation temperature in the coalescence is equal to or higher than the cloud point of the nonionic surfactant.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for addressing the above problems include the following aspect.

According to an aspect of the present disclosure, there is provided a manufacturing method of an electrostatic charge image developing toner having first aggregation of aggregating resin particles for a core in a raw material dispersion B for a core at an aggregation temperature equal to or lower than a glass transition temperature Tg of the resin particles for a core to form aggregated core particles, the raw material dispersion B for a core being obtained by adding an ionic compound having a monovalent cation to a raw material dispersion A for a core, that contains the resin particles for a core having a glass transition temperature lower than 40° C. and having an ester structure, a nonionic surfactant, and an aqueous medium,
second aggregation of mixing an aggregated core particle dispersion containing the aggregated core particles and the aqueous medium with a resin particle dispersion for a shell containing resin particles for a shell having an ester structure and an aqueous medium and aggregating the resin particles for a shell with the resin particles for a core in a mixed dispersion containing the aggregated core particles and the resin particles for a shell at an aggregation temperature equal to or lower than a glass transition temperature Tg of the resin particles for a shell to form aggregated core particles with a shell, and
coalescence of coalescing the aggregated core particles with a shell at a coalescence temperature that is equal to or higher than the glass transition temperatures of the resin particles for a core and the resin particles for a shell and lower than a cloud point of the nonionic surfactant.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing an example of the configuration of the process cartridge according to the present exemplary embodiment.

### DETAILED DESCRIPTION

The exemplary embodiments as an example of the present invention will be described below. The following descriptions and examples merely illustrate the present invention, and do not limit the present invention.

In the present specification, a range of numerical values described using “to” represents a range including the numerical values listed before and after “to” as the minimum value and the maximum value respectively.

Regarding the ranges of numerical values described in stages in the present specification, the upper limit or lower limit of a range of numerical values may be replaced with the upper limit or lower limit of another range of numerical values described in stages. Furthermore, in the present specification, the upper limit or lower limit of a range of numerical values may be replaced with values described in examples.

In the present specification, the term “step” includes not only an independent step but a step which is not clearly distinguished from other steps as long as the intended goal of the step is achieved.

In the present specification, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present specification, each component may include a plurality of corresponding substances. In a case where the amount of each component in a composition is mentioned in the present disclosure, and there are two or more substances corresponding to each component in the composition, unless otherwise specified, the amount of each component means the total amount of two or more of the substances present in the composition.

In the present specification, “electrostatic charge image developing toner” will be also simply called “toner”.

Manufacturing Method of Electrostatic Charge Image Developing Toner

The manufacturing method of a toner according to the present exemplary embodiment has
a first aggregation step of aggregating resin particles for a core in a raw material dispersion B for a core at an aggregation temperature equal to or lower than a glass transition temperature Tg of the resin particles for a core to form aggregated core particles, the raw material dispersion B for a core being obtained by adding an ionic compound having a monovalent cation to a raw material dispersion A for a core, that contains the resin particles for a core having a glass transition temperature lower than 40° C. and having an ester structure, a nonionic surfactant, and an aqueous medium,
a second aggregation step of mixing a dispersion containing the aggregated core particles and the aqueous medium with a resin particle dispersion for a shell containing resin particles for a shell having an ester structure and an aqueous medium and aggregating the resin particles for a shell with the resin particles for a core in a mixed dispersion containing the aggregated core particles and the resin particles for a shell at an aggregation temperature equal to or lower than a glass transition temperature Tg of the resin particles for a shell to form aggregated core particles with a shell, and
a coalescence step of coalescing the aggregated core particles with a shell at a coalescence temperature that is equal to or higher than the glass transition temperatures of the resin particles for a core and the resin particles for a shell and lower than a cloud point of the nonionic surfactant.

Due to the above steps, the manufacturing method of a toner according to the present exemplary embodiment makes it possible to obtain a toner suppressing gloss unevenness. The reason is presumed as follows.

In recent years, a toner has been known which uses a resin having a low glass transition temperature Tg (specifically, a resin that has a glass transition temperature lower than 40° C. and has an ester structure) to develop a low-temperature fixing toner for energy saving.

In addition, toners have been required to have recording media versatility that enable the toners to be applicable to various recording media such as a transparent film.

However, these toners sometimes cause gloss unevenness. Particularly, for example, when an image (high density image) is formed on a film at a high speed in a high temperature environment by applying large amounts of the toner, partial gloss unevenness is likely to occur.

In a case where the surface and cross section of the image in which gloss unevenness has occurred is observed, micro-roughness that looks like foams (so-called blisters) is found to occur on the image surface. Furthermore, in a case where the cross section of toner particles in which gloss unevenness has occurred is observed, the toner particles are found to have a lot of internal voids, and the more the surfactant in the toner, the more the internal voids.

Presumably, the above phenomenon may occur for the following reason. In a case where a divalent or trivalent metal aggregating agent and an anionic surfactant are used in a manufacturing method of toner particles by an aggregation and coalescence method using resin particles having a low glass transition temperature Tg and having an ester structure, even though the aggregation temperature is at a level of room temperature of 20° C. or higher and 30° C. or lower, particles are likely to be rapidly aggregated, and homoaggregation more dominantly occurs, which leads to the formation of aggregates having many voids (water inclusions or foams). Particularly, in a case where an anionic surfactant is used as a surfactant, foaming is likely to occur, and the resin particles including the generated foams are aggregated, which leads to the formation of aggregates having many voids.

Especially, in a case where a toner is heated and melted in a step of fixing the toner to a transparent film as a recording medium, the water inclusions or air in the internal void portions escape from the image. However, compared to an image formed on plain paper, an image formed on a transparent film having few roughness has fewer spaces through which air and moisture escape. Therefore, air and moisture selectively escape from the image surface side and cause foaming, micro-roughness occurs, and visible light is refracted at the portion of the micro-roughness, which leads to gloss unevenness.

Therefore, in the manufacturing method of a toner according to the present exemplary embodiment, as a material that also has an aggregating function, an ionic compound is used which has low reactivity with resin particles having an ester structure and has a monovalent cation having a weak aggregating force.

As a surfactant, a nonionic surfactant that foams less compared to an anionic surfactant is used. The nonionic surfactant is unlikely to interact with an ionic compound having a monovalent cation, and is unlikely to increase the aggregating force.

Furthermore, in the first aggregation step and the second aggregation step, each type of resin particles are aggregated at an aggregation temperature equal to or lower than the glass transition temperatures of the resin particles for a core and the resin particles for a shell.

As a result, each type of resin particles are aggregated slowly and densely, which makes it possible to obtain aggregated core particles with a shell having few voids.

In a case where the aggregated core particles with a shell are then coalesced at a coalescence temperature equal to or higher than the glass transition temperatures of the resin particles for a core and the resin particles for a shell and less than a cloud point of the nonionic surfactant, dense toner particles having few internal voids are obtained. As the reason, presumably, performing coalescence at a temperature equal to or higher than the glass transition temperatures of the resin particles for a core and the resin particles for a shell may allow the resin to have vigorous molecular motion in a rubber state, and water and the like included in the space between the resin particles may be discharged, which may lead to the formation of toner particles composed of resin particles that are sufficiently fused with each other. Furthermore, in a case where coalescence is performed at a temperature equal to or higher than the cloud point of the nonionic surfactant, the solubility of the nonionic surfactant in water decreases, and some parts of the nonionic surfactant are precipitated and becomes turbid. The precipitated parts are difficult to be discharged and are likely to remain on the inside of the toner particles as turbid parts. Presumably, in a case where the nonionic surfactant remains on the inside of the toner particles, incident light may be refracted at the interface between the resin material and the nonionic surfactant during the image formation, which may induce gloss unevenness. The parts of the nonionic surfactant that are dissolved in water are considered to be discharged outside the toner particles together with water in the coalescence step. Therefore, coalescence is performed at an aggregation and coalescence temperature lower than a cloud point of the nonionic surfactant.

It is presumed that a toner suppressing gloss unevenness may be obtained for the above reasons.

Hereinafter, the manufacturing method of a toner according to the present exemplary embodiment will be specifically described.

In the manufacturing method of a toner according to the present exemplary embodiment, toner particles are manufactured through a first aggregation step, a second aggregation step, and a coalescence step. In the manufacturing method of a toner according to the present exemplary embodiment, after toner particles are manufactured, an external additive may be added to the exterior of the toner particles.

Hereinafter, each of the steps will be specifically described.

In the following section, a method of obtaining toner particles containing a binder resin, a colorant, and a release agent will be described. The colorant and the release agent are used as necessary. It goes without saying that other additives different from the colorant and the release agent may also be used.

First Aggregation Step

In the first aggregation step, resin particles for a core are aggregated in a raw material dispersion B for a core at an aggregation temperature equal to or lower than a glass transition temperature Tg of the resin particles for a core to form aggregated core particles, the raw material dispersion B for a core being obtained by adding an ionic compound having a monovalent cation as a material also having an aggregating function to a raw material dispersion A for a core, that contains the resin particles for a core having a glass transition temperature lower than 40° C. and having an ester structure, colorant particles, release agent particles, a nonionic surfactant, and an aqueous medium.

Specifically, in the first aggregation step, a resin particle dispersion for a core containing resin particles for a core and an aqueous medium, a colorant particle dispersion containing colorant particles and an aqueous medium, a release agent dispersion containing release agent particles and an aqueous medium, and a nonionic surfactant are mixed together, and then an ionic compound that also has an aggregating function is added to a raw material dispersion A for a core containing the above particles and the nonionic surfactant. In this way, each type of particles are heteroaggregated in a raw material dispersion B for a core, and aggregated core particles are formed.

It is preferable that the raw material dispersion A for a core be obtained using, for example, a core resin particle dispersion containing resin particles for a core, a nonionic surfactant, and an aqueous medium.

In addition, it is preferable that the ionic compound also having an aggregating function be added to the raw material dispersion B for a core for, for example, 5 minutes or longer.

The resin particles for a core (specifically, a resin particle dispersion for a core) may be added to the raw material dispersion B for a core, to which the ionic compound that also has an aggregating function is added, while the resin particles for a core are being aggregated. The resin particles for a core may be continuously or collectively added to the raw material dispersion B for a core to which the ionic compound also having an aggregating function is added, or may be added to the raw material dispersion B for a core in two or more divided portions.

The ionic compound may be continuously or collectively added to the raw material dispersion A for a core or may be added to the dispersion in two or more divided portions.

In a case where the resin particles for a core and the ionic compound are added to each dispersion in two or more divided portions, heteroaggregation dominantly occurs. As a result, the obtained aggregated particles (that is, toner particles) are likely to have a low internal porosity, and the occurrence of gloss unevenness is further suppressed.

The nonionic surfactant and the ionic compound may be diluted with or dissolved in an aqueous medium, and the obtained solution may be used.

In the first aggregation step, the glass transition temperature (Tg) of the resin particles for a core is lower than 40° C. From the viewpoint of low temperature fixability, Tg of the resin particles for a core is, for example, preferably 35° C. or lower, and more preferably 30° C. or lower.

The glass transition temperature of the resin particles for a core is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

In the first aggregation step, the volume-average particle size of the resin particles for a core is, for example, preferably 5 nm or more and 500 nm or less, more preferably 10 nm or more and 300 nm or less, and even more preferably 10 nm or more and 120 nm or less.

In a case where the volume-average particle size of the resin particles for a core is within the above range, the resin particles for a core are likely to be aggregated slowly and densely. As a result, the obtained aggregated particles (that is, toner particles) are likely to have a low internal porosity, and the occurrence of gloss unevenness is further suppressed.

The volume-average particle size of the resin particles for a core is measured by the following method.

The particle size distribution is measured with a laser diffraction/scattering type particle size distribution analyzer (for example, LA-700, manufactured by HORIBA, Ltd.). Based on the particle size range (channel) that is divided based on the measured particle size distribution, a cumulative volume distribution is drawn from small-sized particles. The particle size at which the cumulative percentage of the particles reaches 50% is defined as a volume-average particle size D50v.

The proportion of particles having a particle size of 100 nm or less is determined by accumulating the frequency of particles counted in the particle size range (channel) of 0 to 100 nm among the measured and detected particles.

In the first aggregation step, the amount of the nonionic surfactant in the raw material dispersion A for a core with respect to the resin particles for a core is, for example, preferably 0.05% by mass or more and 10% by mass or less, and more preferably 0.5% by mass or more and 7% by mass or less.

Here, the amount of the nonionic surfactant in the raw material dispersion A for a core means the amount of the nonionic surfactant contained in the resin particle dispersion for a core, and nonionic surfactants contained in the colorant particle dispersion, the release agent particle dispersion, and a crystalline resin particle dispersion are excluded.

In a case where the amount of the nonionic surfactant is in the above range, the resin particles for a core are likely to be aggregated slowly and densely. As a result, the obtained aggregated particles (that is, toner particles) are likely to have a low internal porosity, and the occurrence of gloss unevenness is further suppressed.

In the first aggregation step, the raw material dispersion A for a core may contain a pH adjuster having a pH of 7.5 or higher. The pH adjusting adjuster may be continuously or collectively added to the raw material dispersion A for a core or may be added to the dispersion in two or more divided portions.

Adding the pH adjusting adjuster to the dispersion to adjust pH of the raw material dispersion A for a core or adding the pH adjuster to the dispersion in two or more divided portions allows heteroaggregation to dominantly occur. As a result, the obtained aggregated particles (that is, toner particles) are likely to have a low internal porosity, and the occurrence of gloss unevenness is further suppressed.

In the first aggregation step, the raw material dispersion A for a core may contain a viscosity adjuster. The viscosity adjuster may be continuously or collectively added to the raw material dispersion A for a core or may be added to the dispersion in two or more divided portions.

In a case where the viscosity adjuster is added to the dispersion to adjust the viscosity of the raw material dispersion A for a core, the resin particles for a core are likely to be aggregated slowly and densely. As a result, the obtained aggregated particles (that is, toner particles) are likely to have a low internal porosity, and the occurrence of gloss unevenness is further suppressed.

In the first aggregation step, the aggregation temperature is equal to or lower than the glass transition temperature Tg of the resin particles for a core. From the view point of reducing the internal porosity of the toner particles and suppressing gloss unevenness, Tg of the resin particles for a core is, for example, preferably equal to or higher than (glass transition temperature of resin particles for core−15° C.) and equal to or lower than (glass transition temperature of resin particles for core−3° C.).

In the first aggregation step, for example, it is preferable to aggregate the resin particles for a core while stirring the raw material dispersion B for a core at a stirring power consumption of 0.01 kW/m 3 or more and 9.0 kW/m³ or less (for example, preferably, preferably 0.1 kW/m³ or more and 6.0 kW/m³ or less, and more preferably 0.2 kW/m³ or more and 3.0 kW/m³ or less) per unit volume of the raw material dispersion B for a core to which the ionic compound also having an aggregating function is added.

The viscosity of the raw material dispersion B for a core, to which the ionic compound also having an aggregating function is added, during stirring at 25° C. and a shear rate of 1/s is, for example, preferably 1 Pa·s or more and 100 Pa·s or less, more preferably 2 Pa·s or more and 50 Pa·s or less, and even more preferably 5 Pa·s or more and 30 Pa·s or less.

In a case where the stirring power consumption and the viscosity are in the above ranges, the balance between the aggregation of the resin particles for a core and the disintegration of the aggregated particles by the shearing force is controlled, and aggregated particles are formed dominantly by heteroaggregation. As a result, the obtained aggregated particles (that is, toner particles) are likely to have a low internal porosity, and the occurrence of gloss unevenness is further suppressed.

The stirring power consumption per unit volume is calculated as follows.

Stirring power consumption per unit volume (kW/m³)=Np×n³d⁵/V

The meanings of the reference numerals are as follows.

Np: power number (−)=P/(ρn³d⁵)
n: rotation speed (rad/sec)
d: diameter of stirring blade (m)
V: volume (m³)
P: power (W)
ρ: liquid density (kg/m³)

The viscosity of the raw material dispersion B for a core, to which the ionic compound also having an aggregating function is added, during stirring at a shear rate of 1/s means the viscosity of the dispersion at a point in time when the ionic compound having a monovalent cation has been added to the raw material dispersion A for a core.

The viscosity at a shear rate of 1/s is measured by the following method.

First, a rotary viscometer is used as a measurement device. One of the examples of the rotary viscometer is an R/S plus rheometer (spindle: CP-75-1) manufactured by AIETEK Brookfield. The rotary viscometer is installed in an environment of a temperature of 22° C. to 25° C. and a relative humidity of 55%. During stirring, a sample to be measured is collected from a plurality of dispersions, and the viscosity of the dispersion being stirred is measured.

Specifically, as a sample, 3 g of a dispersion having a temperature adjusted to 25° C. is stirred at a shear rate (s⁻¹) that is increased and then reduced by 0.2 per second in a shear rate range of 0.5/s or more and 12/s or less, and a shear stress (Pa) is measured every 2 seconds. The common logarithm of the shear rate (s⁻¹) is plotted on the abscissa, the common logarithm of the viscosity (Pa·s) determined from the shear stress (Pa) and the shear rate (s⁻¹) is plotted on the ordinate, and viscosity versus shear rate is plotted. In this way, straight lines showing the viscosity during the increase and decrease of the shear rate are drawn.

In each of the straight lines showing the viscosity during the increase and decrease of the shear rate, the viscosity (Pa·s) at 1/s is determined from the common logarithm of viscosity (intercept of the straight line) at 1/s (the common logarithm of the shear rate=0), and the values of viscosity obtained from two straight lines are averaged. The measurement is performed three times, and the obtained values are averaged and adopted as the viscosity (Pa·s) at a shear rate of 1/s.

In the first aggregation step, before the addition of the ionic compound (that is, before aggregation), premixing may be performed in which the raw material dispersion A for a core is cooled to a temperature equal to or lower than the glass transition temperature Tg of the resin particles for a core by using a cooling facility in a state where the raw material dispersion A for a core is being stirred at a stirring power consumption per unit volume of 0.05 (kW/m³) or more and 1.0 (kW/m³) or less.

In the first aggregation step, the concentration of solid content of the aggregated core particle dispersion to be obtained that contains aggregated core particles and an aqueous medium is, for example, preferably 2% by mass or more and 20% by mass or less, more preferably 5% by mass or more and 18% by mass or less, and even more preferably 10% by mass or more and 17% by mass or less.

In a case where the concentration of solid content of the aggregated core particle dispersion is in the above range, the resin particles for a core are likely to be aggregated slowly and densely. As a result, the obtained aggregated particles (that is, toner particles) are likely to have a low internal porosity, and the occurrence of gloss unevenness is further suppressed.

Second Aggregation Step

In the second aggregation step, the aggregated core particle dispersion containing the aggregated core particles and the aqueous medium is mixed with a resin particle dispersion for a shell containing resin particles for a shell having an ester structure and an aqueous medium, and the resin particles for a shell are aggregated with the resin particles for a core at an aggregation temperature equal to or lower than a glass transition temperature Tg of the resin particles for a shell in a mixed dispersion containing the aggregated core particles and the resin particles for a shell to form aggregated core particles with a shell.

Specifically, for example, in the second aggregation step, when the aggregated core particles reach the intended particle size in the first aggregation step, the resin particle dispersion for a shell containing the resin particles for a shell and an aqueous medium is added to the aggregated core particle dispersion containing the aggregated core particles and an aqueous medium. Then, in the mixed dispersion containing the aggregated core particles and the resin particles for a shell, the resin particles for a shell may be aggregated with the resin particles for a core at an aggregation temperature equal to or lower than the glass transition temperature Tg of the resin particles for a shell, such that the aggregated core particles with a shell having a diameter close to the diameter of target toner particles may be formed.

A release agent particle dispersion may be added to the aggregated core particle dispersion together with the resin particle dispersion for a shell. Furthermore, a dispersion prepared by adding the release agent particle dispersion to the resin particle dispersion for a shell in advance may be added to the aggregated core particle dispersion. In a case where the above dispersions are added, aggregated core particles with a shell are obtained in which the resin particles for a shell and the release agent particles are aggregated with the aggregated core particles.

In the second aggregation step, the aggregation operation described above may be repeated two or more times. That is, the second aggregation step may be performed a plurality of times. For example, the addition of the resin particle dispersion for a shell and the release agent particle dispersion to the aggregated core particle dispersion may be carried out by at least one aggregation operation among aggregation operations performed two or more times except for the last aggregation operation.

At least either the nonionic surfactant or the ionic compound having a monovalent cation as a material also having an aggregating function may be further added to the mixed dispersion containing the aggregated core particles and the resin particles for a shell.

The ionic compound used in the second aggregation step is, for example, preferably an ionic compound having aggregating force equivalent to or higher than the aggregating force of the ionic compound used in the first aggregation step in the Hofmeister series. Furthermore, it is preferable that the ionic compound as a material also having an aggregating function be added to the mixed dispersion for, for example, 5 minutes or longer.

The resin particle dispersion for a shell may be continuously or collectively added to the aggregated core particle dispersion or may be added to the dispersion in two or more divided portions.

The ionic compound may be continuously or collectively added to the mixed dispersion or may be added to the dispersion in two or more divided portions.

In a case where the resin particle dispersion for a shell and the ionic compound are added to each dispersion in two or more divided portions, heteroaggregation dominantly occurs. As a result, the obtained aggregated particles (that is, toner particles) are likely to have a low internal porosity, and the occurrence of gloss unevenness is further suppressed.

The nonionic surfactant and the ionic compound may be diluted with or dissolved in an aqueous medium, and the obtained solution may be used.

The glass transition temperature of the resin particles for a shell is, for example, preferably higher than the glass transition temperature of the resin particles for a core.

Specifically, the difference in glass transition temperature between the resin particles for a shell and the resin particles for a core is, for example, preferably 1° C. or higher and 40° C. or lower, more preferably 5° C. or higher and 40° C. or lower, and even more preferably 10° C. or higher and 40° C. or lower.

The glass transition temperature of the resin particles for a shell is, for example, preferably 40° C. or higher and 70° C. or lower, more preferably 45° C. or higher and 65° C. or lower, and even more preferably 50° C. or higher and 65° C. or lower.

In a case where the glass transition temperature of the resin particles for a shell satisfies the above relationship or the above range, the resin particles for a shell sufficiently flow in the second aggregation step, and the water inclusions and the like that are between the resins for a shell and between the resin for a shell and the resin for a core are discharged outside the toner particles, which makes it easy to obtain aggregated particles (that is, toner particles) having a low internal porosity. In addition, the formation of coarse particles resulting from the increase in temperature in the printing machine during image formation is suppressed. Accordingly, the occurrence of roughness of the image layer is suppressed, which suppresses the occurrence of gloss unevenness.

The glass transition temperature of the resin particles for a shell is measured by the same method as the method of measuring the glass transition temperature of the resin particles for a core.

The absolute value of a difference in a solubility parameter between the resin particles for a core and the resin particles for a shell is, for example, preferably 0 or more and 1.5 or less, more preferably 0 or more and 1.2 or less, and even more preferably 0 or more and 0.9 or less.

In a case where the difference in a solubility parameter is in the above range, the resin particles for a shell are likely to be densely aggregated with the aggregated core particles. As a result, the obtained aggregated particles (that is, toner particles) are likely to have a low internal porosity, and the occurrence of gloss unevenness is further suppressed.

The solubility parameter (SP value=δ) of the resin particles is a value defined by the following equation as a function of aggregation energy density.

δ=(ΔE/V)^{1/2}
ΔE: intermolecular aggregation energy (heat of evaporation)
V: total volume of mixed solution
ΔE/V: aggregation energy density

In a case where the monomer composition of a resin is known, the SP value can be calculated using the following method of Fedor et a1. (the method described in Polym. Eng. Sci., 14 [2] (1974)).

SP value=(ΣΔei/ΣΔvi)^{1/2}
Δei: evaporation energy of atom or atomic group
Δvi: molar volume of atom or atomic group
As the SP value described in the present specification, a value calculated from the monomer composition is mainly used.

In the second aggregation step, the amount of the resin particles for a shell with respect to the resin particles for a core (that is, the proportion of the resin particles for a shell mixed with the resin particles for a core) is, for example, preferably 40% by mass or less, more preferably 1% by mass or more and 30% by mass or less, and even more preferably 5% by mass or more and 25% by mass or less.

In a case where the amount of the resin particles for a shell is in the above range, the resin particles for a shell are likely to be densely aggregated with the aggregated core particles. As a result, the obtained aggregated particles (that is, toner particles) are likely to have a low internal porosity, and the occurrence of gloss unevenness is further suppressed.

In the second aggregation step, for example, the concentration of solid content of the resin particle dispersion for a shell is preferably higher than the concentration of solid content of the aggregated core particle dispersion.

The difference between the concentration of solid content of the resin particle dispersion for a shell and the concentration of solid content of the aggregated core particle dispersion (concentration of solid content of the resin particle dispersion for shell—concentration of solid content of aggregated core particle dispersion) is, for example, preferably 2% by mass or more and 40% by mass or less, more preferably 3% by mass or more and 30% by mass or less, and even more preferably 5% by mass or more and 25% by mass or less.

The concentration of solid content of the resin particle dispersion for a shell is, for example, preferably 3% by mass or more and 50% by mass or less, more preferably 10% by mass or more and 40% by mass or less, and even more preferably 15% by mass or more and 35% by mass or less.

In a case where the concentration of solid content of the resin particle dispersion for a shell satisfies the above relationship or the above range, the resin particles for a shell are likely to be slowly and densely aggregated with the aggregated core particles. As a result, the obtained aggregated particles (that is, toner particles) are likely to have a low internal porosity, and the occurrence of gloss unevenness is further suppressed.

In the second aggregation step, the aggregation temperature is equal to or lower than the glass transition temperature Tg of the resin particles for a shell. From the view point of reducing the internal porosity of the toner particles and suppressing gloss unevenness, Tg of the resin particles for a shell is, for example, preferably equal to or higher than (glass transition temperature of resin particles for core−15° C.) and equal to or lower than (glass transition temperature of resin particles for core−3° C.).

In the second aggregation step, for example, it is preferable to aggregate the resin particles for a shell with the aggregated core particles while stirring the mixed raw material dispersion at a stirring power consumption of 0.01 kW/m³ or more and 9.0 kW/m³ or less (for example, preferably 0.1 kW/m³ or more and 6.0 kW/m³ or less, and more preferably 0.2 kW/m³ or more and 3.0 kW/m³ or less) per unit volume of the mixed dispersion.

The viscosity of the mixed dispersion during stirring at 25° C. and a shear rate of 1/s is, for example, preferably 1 Pa·s or more and 100 Pa·s or less, more preferably 2 Pa·s or more and 50 Pa·s or less, and even more preferably 5 Pa·s or more and 40 Pa·s or less.

In a case where the stirring power consumption and the viscosity are in the above ranges, the balance between the aggregation of the resin particles for a shell and the disintegration of the aggregated particles by the shearing force is controlled, and aggregated particles are formed dominantly by heteroaggregation. As a result, the obtained aggregated particles (that is, toner particles) are likely to have a low internal porosity, and the occurrence of gloss unevenness is further suppressed.

In the second aggregation step, for example, when the aggregated core particles with a shell reaches the intended particle size after the above aggregation operation ends, an aggregation terminator is added to the mixed solution to terminate the aggregation of the resin particles for a shell. The aggregation terminator may be added at a point in time when the mixed solution is at a temperature lower than the glass transition temperature of the resin particles for a shell.

Coalescence Step

In the coalescence step, the aggregated core particles with a shell are coalesced at a coalescence temperature that is equal to or higher than the glass transition temperatures of the resin particles for a core and the resin particles for a shell and lower than a cloud point of the nonionic surfactant.

In the coalescence step, from the view point of reducing the internal porosity of the toner particles and suppressing gloss unevenness, the coalescence temperature is, for example, preferably equal to or higher than (glass transition temperatures of resin particles for core and resin particles for shell+5° C.) and equal to or lower than (cloud point of nonionic surfactant−3° C.). Specifically, the coalescence temperature is, for example, preferably 75° C. or higher and 100° C. or lower. The toner particles may contain a release agent. In this case, it is preferable that the toner particles be coalesced at a temperature equal to or higher than (melting point of release agent−15° C.) and equal to or lower than (cloud point of nonionic surfactant−3° C.).

The difference between the cloud point of the nonionic surfactant and the glass transition temperature of the resin particles for a shell (cloud point of nonionic surfactant—glass transition temperature of resin particles for shell) is, for example, preferably 30° C. or higher, and more preferably 40° C. or higher.

The cloud point of the nonionic surfactant is, for example, preferably 80° C. or higher, and more preferably 100° C. or higher.

The cloud point of the nonionic surfactant is, for example, preferably a temperature higher than the coalescence temperature. In a case where coalescence is performed at a temperature equal to or higher than the cloud point of the nonionic surfactant, the solubility of the nonionic surfactant in water decreases, and some parts of the nonionic surfactant are precipitated and becomes turbid. The precipitated parts are difficult to be discharged and are likely to remain on the inside of the toner particles as turbid parts. Presumably, in a case where the nonionic surfactant remains on the inside of the toner particles, incident light may be refracted at the interface between the resin material and the nonionic surfactant during the image formation, which may induce gloss unevenness. The parts of the nonionic surfactant that are dissolved in water are considered to be discharged outside the toner particles together with water in the coalescence step. Therefore, it is preferable that coalescence be performed, for example, at a temperature lower than the cloud point of the nonionic surfactant.

The cloud point of the nonionic surfactant is measured by the following method.

Deionized water (20 mL) is put in a pressure-resistant test tube, 3% by mass of a nonionic surfactant is added thereto, and the mixture is sealed with a lid. The sealed test tube is immersed in a thermostatic bath and shaken, and in this state, the test tube is heated at a rate of 1° C./10 min until turbidness appears. Heating is stopped at a temperature 2° C. higher than the temperature at which turbidness appears, the test tube is cooled at a rate of 1° C./10 min to a temperature 2° C. lower than a temperature at which turbidness disappears, and the temperature at the midpoint between the temperature at which turbidness appears and the temperature at which turbidness disappears is adopted as a cloud point.

In the coalescence step, for example, it is preferable to coalesce the aggregated core particles with a shell until the internal porosity of the obtained toner particles is 5% or less (for example, preferably 4% or less).

In a case where the aggregated core particles with a shell are coalesced until the internal porosity of the obtained toner particles falls into the above range, the obtained toner particles are likely to have a low internal porosity, and the occurrence of gloss unevenness is further suppressed.

The internal porosity of the toner particles is measured as follows.

A cross section obtained by cutting the toner particles (or the toner) is stained, and an observation image obtained using a transmission electron microscope (TEM) or a scanning electron microscope (SEM) is analyzed to measure the internal porosity. Specifically, for example, the following method is used, but the present invention is not limited thereto. As a staining agent, a proper substance is selected from ruthenium tetroxide, osmium tetroxide, phosphotungstic acid, uranyl acetate, iodine, and the like, such that the degree of staining varies with the material depending on the type of binder resin and the like.

A bisphenol A-type liquid epoxy resin (7 g, manufactured by Asahi Kasei Corporation.) and 3 g of ZENAMID250 (manufactured by Henkel Japan Ltd.) as a curing agent are gently mixed together and prepared, then 1 g of the toner is mixed in, and the mixture is left to stand for 24 hours, thereby obtaining a cured substance. A cutting sample in which the cured substance is embedded at −100° C. is cut using a cutting device LEICAUltra Microtome (ULTRACUT UCT model, manufactured by Hitachi High-Tech Corporation.) equipped with a diamond knife (Type Cryo model, manufactured by DIATOME), thereby preparing an observation sample. This observation sample is left in a desiccator in an environment of ruthenium tetroxide (manufactured by Soegawa Rikagaku Co., Ltd.) and stained (the degree of staining is judged from the degree of staining of a tape left together with the sample). The stained observation sample is observed with a Hitachi high-resolution field emission scanning electron microscope (S-4800, manufactured by Hitachi High-Tech Corporation) equipped with a transmission electron detector at a magnification of 10,000× or more and 100,000× or less to observe the cross-sectional view of the stained toner. The observed TEM image is digitized and then imported into the image analysis software (Win ROOF) manufactured by MITANI CORPORATION, the cross-sectional area of the toner in the embedding agent is selected as a selection target, binarization processing is performed using “automatic binarization-discriminant analysis” of the command “binarization processing”, and the ratio of porous portions to the cross-sectional area of the toner particles is calculated for 1,000 toner particles.

The type of material is determined by comparing the individual materials, such as an amorphous resin, a crystalline resin, a colorant, and a release agent, and the stained mixtures thereof, and the black portion that corresponds to none of the materials is treated as a void portion.

In a case where binarization cannot be normally performed due to the imaging density, noise, and the like of the image, the image is sharpened by performing “filter-median” processing or edge extraction processing, and then the boundary is manually set.

Toner particles are formed through the above steps.

After the coalescence step, the toner particles formed in a solution undergo a known washing step, solid-liquid separation step, and drying step, thereby obtaining dry toner particles.

As the washing step, for example, in view of charging properties, it is preferable to sufficiently perform displacement washing by using water for washing.

Particularly, from the viewpoint of thoroughly removing the nonionic surfactant, for example, it is preferable to wash the toner particles by repeating a step under the conditions of a temperature of water for washing of equal to or higher than (glass transition temperature of resin particles for core) and equal to or lower than (glass transition temperature of resin particles for core+20° C.), amount of water for washing of 15 L/kg or more with respect to the toner particles, (adjusting pH of the toner dispersion to be 9 or more and 13 or less, stirring the dispersion for 5 minutes or more, followed by filtration), and (adjusting pH of the toner dispersion to be 1 or more and 5 or less, stirring the dispersion for 5 minutes or more, followed by filtration).

The solid-liquid separation step is not particularly limited. However, in view of productivity, suction filtration, pressure filtration, or the like may be performed.

The method of the drying step is not particularly limited. However, in view of productivity, freeze drying, flush drying, fluidized drying, vibratory fluidized drying, or the like may be performed.

Particularly, from the viewpoint of drying efficiency and suppression of the generation of coarse particles, for example, it is preferable that drying be performed under a temperature condition of equal to or higher than 5° C. and equal to or lower than (glass transition temperature of resin particles for shell−10° C.).

For example, by adding an external additive to the obtained dry toner particles and mixing the external additive and the toner particles together, the toner according to the present exemplary embodiment is manufactured. The mixing may be performed, for example, using a V blender, a Henschel mixer, a Lodige mixer, or the like. Furthermore, coarse particles of the toner may be removed as necessary by using a vibratory sieving machine, a pneumatic sieving machine, or the like.

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, MgSO₄, and the like.

The surface of the inorganic particles as an external additive may have undergone, for example, a hydrophobic treatment. The hydrophobic treatment is performed, for example, by immersing the inorganic particles in a hydrophobic agent. The hydrophobic agent is not particularly limited, and examples thereof include a silane-based coupling agent, silicone oil, a titanate-based coupling agent, an aluminum-based coupling agent, and the like. Each of these agents may be used alone, or two or more of these agents may be used in combination.

Usually, the amount of the hydrophobic agent is, for example, 1 part by mass or more and 10 parts by mass or less with respect to 100 parts by mass of the inorganic particles.

Examples of external additives also include resin particles (resin particles such as polystyrene, polymethylmethacrylate (PMMA), and melamine resins), a cleaning activator (for example, a metal salt of a higher fatty acid represented by zinc stearate or fluorine-based polymer particles), and the like.

The amount of the external additives added to the exterior of the toner particles with respect to the toner particles is, for example, preferably 0.01% by mass or more and 5% by mass or less, and more preferably 0.01% by mass or more and 2.0% by mass or less.

Characteristics of Toner Particles and the Like

The characteristics of the toner particles obtained by the manufacturing method of a toner according to the present exemplary embodiment are as follows.

The volume-average particle size (D50v) of the toner particles is, for example, preferably 2 μm or more and 15 μm or less, and more preferably 4 μm or more and 8 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 μmg or more and 50 μmg or less is added to 2 ml of a 5% aqueous solution of a surfactant (preferably sodium alkylbenzene sulfonate, for example) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume-average particle size distribution index (GSDv) is calculated as (D84v/D16v)^{1/2}, and a number-average particle size distribution index (GSDp) is calculated as (D84p/D16p)^{1/2}.

The average circularity of the toner particles is, for example, preferably 0.94 or more and 1.00 or less, and more preferably 0.95 or more and 0.98 or less.

The average circularity of the toner particles is determined by (circular equivalent perimeter)/(perimeter) [(perimeter of circle having the same projected area as particle image)/(perimeter of projected particle image)]. Specifically, the average circularity is a value measured by the following method.

First, toner particles as a measurement target are collected by suction, and a flat flow of the particles is formed. Then, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains external additives, the toner (developer) as a measurement target is dispersed in water containing a surfactant, then the dispersion is treated with ultrasonic waves such that the external additives are removed, and the toner particles are collected.

Various Materials Used in Manufacturing Method of Electrostatic Charge Image Developing Toner

Hereinafter, various materials used in the manufacturing method of an electrostatic charge image developing toner will be described.

Resin Particle Dispersion

The resin particle dispersion for a core and the resin particle dispersion for a shell (hereinafter, collectively called “resin particle dispersion” as well) are prepared, for example, by dispersing resin particles in a dispersion medium by using a surfactant.

As the resin particles used as the resin particles for a core and the resin particles for a shell, resin particles having an ester structure (specifically, amorphous resin particles) are used.

Crystalline resin particles may be used in combination with the amorphous resin particles used as the resin particles for a core and the resin particles for a shell. That is, crystalline resin particles may be used in addition to the resin particles for a core and the resin particles for a shell. It is preferable that the crystalline resin particles be contained, for example, in the raw material dispersion A for a core.

Here, in a case where the amorphous resin particles and the crystalline resin particles are used in combination, the amorphous resin particles and the crystalline resin particles are preferably used such that the mass ratio of the crystalline resin to the amorphous resin used in the toner particles (crystalline resin/amorphous resin) is, for example, preferably 3/97 or more and 50/50 or less, and more preferably 7/93 or more and 30/70 or less.

The amorphous resin means a resin which shows only a stepwise change in amount of heat absorbed instead of having a clear endothermic peak in a case where the resin is measured by a thermoanalytical method using differential scanning calorimetry (DSC), and stays as a solid at room temperature but turns thermoplastic at a temperature equal to or higher than a glass transition temperature.

In contrast, the crystalline resin means a resin having a clear endothermic peak instead of showing a stepwise change in amount of heat absorbed, in differential scanning calorimetry (DSC).

Specifically, for example, the crystalline resin means a resin which has a half-width of an endothermic peak of 10° C. or less in a case where the resin is measured at a heating rate of 10° C./min, and the amorphous resin means a resin which has a half-width of more than 10° C. or a resin for which a clear endothermic peak is not observed.

The amorphous resin having an ester structure that configures the amorphous resin particles having an ester structure will be described.

Examples of the amorphous resin having an ester structure include an amorphous polyester resin and a hybrid amorphous resin having an amorphous polyester resin segment and a styrene acrylic resin segment.

Here, the hybrid amorphous resin is an amorphous resin in which the amorphous polyester resin segment and the styrene acrylic resin segment are chemically bonded.

Examples of the hybrid amorphous resin include a resin having a main chain that consists of a polyester resin and a side chain that consists of a styrene acrylic resin chemically bonded to the main chain; a resin having a main chain that consists of a styrene acrylic resin and a side chain that consists of a polyester resin chemically bonded to the main chain; a resin having a main chain composed of a polyester resin and a styrene acrylic resin that are chemically bonded to each other; a resin having a main chain that is composed of a polyester resin and a styrene acrylic resin chemically bonded to each other and at least either a side chain that consists of a polyester resin chemically bonded to the main chain or a side chain that consists of a styrene acrylic resin chemically bonded to the main chain; and the like.

The amorphous polyester resin and the styrene acrylic resin of each segment are as described above, and will be not be described again.

The total amount of the polyester resin segment and the styrene acrylic resin segment in the entire hybrid amorphous resin is, for example, preferably 80% by mass or more, more preferably 90% by mass or more, even more preferably 95% by mass or more, and still more preferably 100% by mass.

In the hybrid amorphous resin, the ratio of the styrene acrylic resin segment to the total amount of the polyester resin segment and the styrene acrylic resin segment is, for example, preferably 10% by mass or more and 60% by mass or less, more preferably 20% by mass or more and 55% by mass or less, and even more preferably 30% by mass or more and 50% by mass or less.

It is preferable that the hybrid amorphous resin be manufactured, for example, by any of the following methods (i) to (iii).
(i) Preparing a polyester resin segment by polycondensation of a polyhydric alcohol and a polyvalent carboxylic acid and then adding a monomer configuring a styrene acrylic resin segment by polymerization.
(ii) Preparing a styrene acrylic resin segment by addition polymerization of an addition-polymerizable monomer and then polycondensing a polyhydric alcohol and a polyvalent carboxylic acid.
(iii) Polycondensation of a polyhydric alcohol and a polyvalent carboxylic acid and addition polymerization of an addition-polymerizable monomer are carried out in parallel.

The proportion of the hybrid amorphous resin in the entire binder resin is, for example, preferably 60% by mass or more and 98% by mass or less, more preferably 65% by mass or more and 95% by mass or less, and even more preferably 70% by mass or more and 90% by mass or less.

Hereinafter, the amorphous polyester resin will be described.

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these, lower alkyl esters (for example, having 1 or more and 5 or less carbon atoms) of these, and the like.

One polyvalent carboxylic acid may be used alone, or two or more polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among these, as the polyhydric alcohol, for example, aromatic diols and alicyclic diols are preferable, and aromatic diols are more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One polyhydric alcohol may be used alone, or two or more polyhydric alcohols may be used in combination.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation. In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is being distilled off. In a case where a monomer with poor compatibility takes part in the copolymerization reaction, for example, the monomer with poor compatibility may be condensed in advance with an acid or an alcohol that is to be polycondensed with the monomer, and then polycondensed with the major component.

Examples of the amorphous polyester resin include an unmodified amorphous polyester resin and a modified amorphous polyester resin. The modified amorphous polyester resin is an amorphous polyester resin containing a bonding group other than an ester bond or an amorphous polyester resin containing resin components different from polyester that are bonded by a covalent bond, an ionic bond, or the like. Examples of the modified amorphous polyester resin include a resin having a modified terminal that is obtained by reacting an active hydrogen compound with an amorphous polyester resin having a terminal into which a functional group such as an isocyanate group is introduced.

The proportion of the amorphous polyester resin in the entire binder resin is, for example, preferably 60% by mass or more and 98% by mass or less, more preferably 65% by mass or more and 95% by mass or less, and even more preferably 70% by mass or more and 90% by mass or less.

Hereinafter, the styrene acrylic resin will be described.

The styrene acrylic resin is a copolymer obtained by copolymerizing at least a styrene-based monomer (monomer having a styrene skeleton) and a (meth)acrylic monomer (monomer having a (meth)acrylic group, for example, preferably a monomer having a (meth)acryloxy group). The styrene acrylic resin includes, for example, a copolymer of a monomer of styrenes and a monomer of (meth)acrylic acid esters.

The acrylic resin portion in the styrene acrylic resin is a partial structure obtained by polymerizing either or both of an acrylic monomer and a methacrylic monomer. Furthermore, “(meth)acryl” is an expression including both of “acryl” and “methacryl”.

Examples of the styrene-based monomer include styrene, α-methylstyrene, metachlorostyrene, parachlorostyrene, parafluorostyrene, paramethoxystyrene, meta-tert-butoxystyrene, para-tert-butoxystyrene, and paravinylbenzoic acid, paramethyl-α-methylstyrene, and the like. One styrene-based monomer may be used alone, or two or more styrene-based monomers may be used in combination.

Examples of the (meth)acrylic monomer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, isobornyl (meth)acrylate, 2-hydroxyethyl (meth)acrylate, hydroxypropyl (meth)acrylate, 4-hydroxybutyl (meth)acrylate, and the like. One (meth)acrylic monomer may be used alone, or two or more (meth)acrylic monomers may be used in combination.

The polymerization ratio between the styrene-based monomer and the (meth)acrylic monomer is, for example, preferably styrene-based monomer:(meth)acrylic monomer=70:30 to 95:5 based on mass.

The styrene acrylic resin may have a crosslinked structure. The styrene acrylic resin having a crosslinked structure can be manufactured, for example, by copolymerizing a styrene-based monomer, a (meth)acrylic monomer, and a crosslinking monomer. The crosslinking monomer is not particularly limited, but is preferably a (meth)acrylate compound having 2 or more functional groups, for example.

The method for preparing the styrene acrylic resin is not particularly limited. For example, solution polymerization, precipitation polymerization, suspension polymerization, bulk polymerization, and emulsion polymerization are used. For the polymerization reaction, a known operation (for example, batch polymerization, semi-continuous polymerization, continuous polymerization, or the like) is used.

The characteristics of the amorphous resin will be described.

The weight-average molecular weight (Mw) of the amorphous resin is, for example, preferably 5,000 or more and 1,000,000 or less, and more preferably 7,000 or more and 500,000 or less.

The number-average molecular weight (Mn) of the amorphous resin is, for example, preferably 2,000 or more and 100,000 or less.

The molecular weight distribution Mw/Mn of the amorphous resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC HCL-8120GPC manufactured by Tosoh Corporation as a measurement device, TSKgel·Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

The crystalline resin configuring the crystalline resin particles will be described.

Examples of the crystalline resin include a crystalline resin having an ester structure, specifically, a crystalline polyester resin.

Examples of the crystalline polyester resin include a polycondensate of a polyvalent carboxylic acid and a polyhydric alcohol. As the crystalline polyester resin, a commercially available product or a synthetic resin may be used.

The crystalline polyester resin easily forms a crystal structure. Therefore, for example, a polycondensate which uses not a polymerizable monomer having an aromatic ring but a linear aliphatic polymerizable monomer is preferable.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like), aromatic dicarboxylic acids (for example, dibasic acids such as phthalic acid, isophthalic acid, terephthalic acid, and naphthalene-2,6-dicarboxylic acid), anhydrides of these, and lower alkyl esters (for example, having 1 or more and 5 or less carbon atoms) of these.

As the polyvalent carboxylic acid, a carboxylic acid having a valency of 3 or more that has a crosslinked structure or a branched structure may be used in combination with a dicarboxylic acid. Examples of trivalent carboxylic acids include aromatic carboxylic acids (for example, 1,2,3-benzenetricarboxylic acid, 1,2,4-benzenetricarboxylic acid, 1,2,4-naphthalenetricarboxylic acid, and the like), anhydrides of these, and lower alkyl esters (for example, having 1 or more and 5 or less carbon atoms) of these.

As the polyvalent carboxylic acid, a dicarboxylic acid having a sulfonic acid group and a dicarboxylic acid having an ethylenic double bond may be used in combination with these dicarboxylic acids.

One polyvalent carboxylic acid may be used alone, or two or more polyvalent carboxylic acids may be used in combination.

Examples of the polyhydric alcohol include an aliphatic diol (for example, a linear aliphatic diol having 7 or more and 20 or less carbon atoms in the main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, and the like. As the aliphatic diol, among these, for example, 1,8-octanediol, 1,9-nonanediol, and 1,10-decanediol are preferable.

As the polyhydric alcohol, an alcohol having three or more hydroxyl groups and a crosslinked structure or a branched structure may be used in combination with a diol. Examples of the alcohol having three or more hydroxyl groups include glycerin, trimethylolethane, trimethylolpropane, pentaerythritol, and the like.

One polyhydric alcohol may be used alone, or two or more polyhydric alcohols may be used in combination.

The content of the aliphatic diol in the polyhydric alcohol may be 80 mol % or more and, for example, preferably 90 mol % or more.

The crystalline polyester resin can be obtained by a known manufacturing method, for example, just as the amorphous polyester resin.

As the crystalline polyester resin, for example, a polymer of α,ω-linear aliphatic dicarboxylic acid and α,ω-linear aliphatic diol is preferable.

As the α,ω-linear aliphatic dicarboxylic acid, for example, an α,ω-linear aliphatic dicarboxylic acid is preferable which has an alkylene group that links two carboxy groups and has a carbon number of 3 or more and 14 or less. The carbon number of the alkylene group is, for example, more preferably 4 or more and 12 or less, and even more preferably 6 or more and 10 or less.

Examples of the α,ω-linear aliphatic dicarboxylic acid include succinic acid, glutaric acid, adipic acid, 1,6-hexanedicarboxylic acid (common name: suberic acid), 1,7-heptanedicarboxylic acid (common name: azelaic acid), 1,8-octanedicarboxylic acid (common name: sebacic acid), 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like. Among these, for example, 1,6-hexanedicarboxylic acid, 1,7-heptanedicarboxylic acid, 1,8-octanedicarboxylic acid, 1,9-nonanedicarboxylic acid, and 1,10-decanedicarboxylic acid are preferable.

One α,ω-linear aliphatic dicarboxylic acid may be used alone, or two or more α,ω-linear aliphatic dicarboxylic acids may be used in combination.

As the α,ω-linear aliphatic diol, for example, an α,ω-linear aliphatic diol is preferable which has an alkylene group that links two hydroxy groups and has a carbon number of 3 or more and 14 or less. The carbon number of the alkylene group is, for example, more preferably 4 or more and 12 or less, and even more preferably 6 or more and 10 or less.

Examples of the α,ω-linear aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, 1,18-octadecanediol, and the like. Among these, for example, 1,6-hexanediol, 1,7-heptanediol, 1,8-octanediol, 1,9-nonanediol, and 1,10-decanediol are preferable.

One α,ω-linear aliphatic diol may be used alone, or two or more α,ω-linear aliphatic diols may be used in combination.

As the polymer of the α,ω-linear aliphatic dicarboxylic acid and the α,ω-linear aliphatic diol, for example, from the viewpoint of suppressing image omission, a polymer of at least one compound selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one compound selected from the group consisting of 1,6-hexanediol, 1,7-heptanediol, 1,8-octanediol, 1,9-nonanediol, and 1,10-decanediol is preferable. Among these, for example, a polymer of 1,10-decanedicarboxylic acid and 1,6-hexanediol is more preferable.

The melting temperature of the crystalline resin is, for example, preferably 50° C. or higher and 100° C. or lower, more preferably 55° C. or higher and 90° C. or lower, and even more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline resin is, for example, preferably 6,000 or more and 35,000 or less.

Examples of the aqueous medium used in the resin particle dispersion include distilled water, water such as deionized water, alcohols, and the like. Each of these media may be used alone, or two or more of these media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, from the view point of reducing the internal porosity of the toner particles and suppressing gloss unevenness, for example, a nonionic surfactant is preferably used.

One surfactant may be used alone, or two or more surfactants may be used in combination.

As for the resin particle dispersion, examples of the method for dispersing resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase transition) from W/O to O/W, turns into a discontinuous phase, and is dispersed in the aqueous medium in the form of particles.

The content of the resin particles contained in the resin particle dispersion is, for example, preferably 5% by mass or more and 50% by mass or less, and more preferably 10% by mass or more and 40% by mass or less.

Colorant Particle Dispersion

The colorant particle dispersion is a dispersion obtained by dispersing a colorant in at least an aqueous medium.

The colorant particle dispersion may be obtained by dispersing a colorant in an aqueous medium by using a surfactant.

Examples of colorants include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and the like.

One colorant may be used alone, or two or more colorants may be used in combination.

The aqueous medium used for the colorant particles will be described later.

Examples of the surfactant used for the colorant particles include the surfactant used for the resin particle dispersion.

The colorant is dispersed in an aqueous medium by a known method. For example, a rotary shearing homogenizer, a media-type disperser such as a ball mill, a sand mill, or an attritor, a high-pressure collision type disperser, and the like are preferably used. Furthermore, the colorant may be dispersed in an aqueous medium with a homogenizer by using an ionic surfactant having polarity to prepare the colorant particle dispersion.

The volume-average particle size of the colorant is, for example, preferably 1 μm or less, more preferably 0.5 μm or less, and particularly preferably 0.01 μm or more and 0.5 μm or less.

Release Agent Particle Dispersion

The release agent particle dispersion is a dispersion obtained by dispersing a release agent in at least an aqueous medium.

The release agent particle dispersion may be prepared by dispersing a release agent in an aqueous medium by using a surfactant.

Examples of the release agent include hydrocarbon-based wax; natural wax such as carnauba wax, rice wax, and candelilla wax; synthetic or mineral petroleum-based wax such as montan wax; ester-based wax such as fatty acid esters and montanic acid esters; and the like.

The release agent is not limited to these.

One release agent may be used alone, or two or more release agents may be used in combination.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The aqueous medium used for the release agent particles will be described later.

Examples of the surfactant used for the release agent particles include the surfactant used for the resin particle dispersion.

The release agent is dispersed in an aqueous medium by a known method. For example, a rotary shearing homogenizer, a media-type disperser such as a ball mill, a sand mill, or an attritor, a high-pressure collision type disperser, and the like are preferably used. Furthermore, the release agent may be dispersed in an aqueous medium with a homogenizer by using an ionic surfactant having polarity to prepare the release agent particle dispersion.

The volume-average particle size of the release agent particles is, for example, preferably 1 μm or less, and more preferably 0.01 μm or more and 1 μm or less.

Nonionic Surfactant

Examples of the nonionic surfactant include a polyoxyethylene alkyl ether such as polyoxyethylene lauryl ether, polyoxyethylene stearyl ether, or polyoxyethylene oleyl ether; a polyoxyethylene alkylphenyl ether; a polyoxyethylene fatty acid ester; a sorbitan fatty acid ester; alkyl glycoside; a polyoxyethylene alkylphenyl ether, and the like.

Among these, from the view point of reducing the internal porosity of the toner particles and suppressing gloss unevenness, for example, polyoxyethylene alkyl ethers having a high cloud point is preferable as the nonionic surfactant.

One Nonionic surfactant may be used alone, or two or more nonionic surfactants may be used in combination.

Ionic Compound

As a material that also has an aggregating function, an ionic compound having a monovalent cation is used.

Specifically, examples of the ionic compound include an ionic compound having a monovalent cation and an anion.

Examples of the monovalent cation include NH₄⁺, Rb⁺, K⁺, Na⁺, Li⁺, Cs⁺, and the like.

Examples of the anion include citrate⁽³⁻⁾, SO₄⁽²⁻⁾, PO₄⁽³⁻⁾, HPO₄⁽²⁻⁾, NO₃⁻, Cl⁻, Br⁻, F⁻, I⁻, ClO₄⁻, tartaric acid, acetic acid, and the like.

Among these, for example, an ionic compound having a monovalent cation selected from NH₄⁺, K⁺, and Na⁺ and an anion selected from SO₄⁽²⁻⁾, P₄⁽³⁻⁾, and NO₃⁻ are preferable. Having weak aggregating force, these ionic compounds are likely to cause the resin particles to be slowly and densely aggregated. As a result, the obtained aggregated particles (that is, toner particles) are likely to have a low internal porosity, and the occurrence of gloss unevenness is further suppressed.

Specific examples of the ionic compound include potassium sulfate, ammonium sulfate, sodium sulfate, potassium nitrate, ammonium nitrate, and sodium nitrate. Among these, from the viewpoint of solubility in an aqueous medium and the like, potassium sulfate and ammonium sulfate are exemplified.

One ionic compound may be used alone, or two or more ionic compounds may be used in combination.

PH Adjuster

Examples of the pH adjuster include sodium hydroxide, sodium metasilicate, sodium carbonate, sodium hydrogen carbonate, sodium acetate, potassium hydroxide, calcium hydroxide, barium hydroxide, ammonia, and acids such as nitric acid, sulfuric acid, carbonic acid, hydrochloric acid, and phosphoric acid. In the aggregation step (particularly in the first aggregation step), for example, it is preferable to use sodium hydroxide or potassium hydroxide that does not contain a metal element having a valency of 2 or more, nitric acid, sulfuric acid, and the like among the above.

One pH adjuster may be used alone, or two or more pH adjusters may be used in combination.

Viscosity Adjuster

Examples of the viscosity adjuster include both a thickener and a viscosity reducer.

Examples of the thickener include carboxymethyl cellulose (CMC) and polyvinyl alcohol (PVA).

Examples of the viscosity reducer include various surfactants.

One viscosity adjuster may be used alone, or two or more viscosity adjusters may be used in combination. The viscosity may be adjusted by adjusting the particle size of the dispersion of material particles without using the viscosity adjuster.

Aggregation Terminator

Examples of the aggregation terminator include anionic surfactants such as sodium alkylbenzene sulfonate and alkali metal sulfates of polyoxyethylene alkyl ethers (sodium polyoxyethylene lauryl ether sulfate).

One aggregation terminator may be used alone, or two or more aggregation terminators may be used in combination.

Aqueous Medium

Examples of the aqueous medium include distilled water, water such as deionized water, alcohols, and the like.

One aqueous medium may be used alone, or two or more aqueous media may be used in combination.

Electrostatic Charge Image Developer

The electrostatic charge image developer according to the present exemplary embodiment contains at least a toner obtained by the manufacturing method of a toner according to the present exemplary embodiment.

The electrostatic charge image developer according to the present exemplary embodiment may be a one-component developer which contains only the toner according to the present exemplary embodiment or a two-component developer which is obtained by mixing together the toner and a carrier.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; a resin impregnation-type carrier obtained by impregnating porous magnetic powder with a resin; and the like.

Each of the magnetic powder dispersion-type carrier and the resin impregnation-type carrier may be a carrier obtained by coating a core material, which is particles configuring the carrier, with a coating resin.

Examples of the magnetic powder include magnetic metals such as iron, nickel, and cobalt; magnetic oxides such as ferrite and magnetite; and the like.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond, a product obtained by modifying the straight silicone resin, a fluororesin, polyester, polycarbonate, a phenol resin, an epoxy resin, and the like.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, which are used as necessary, in an appropriate solvent, and the like. The solvent is not particularly limited, and may be selected in consideration of the type of the coating resin used, coating suitability, and the like.

Specifically, examples of the resin coating method include an immersion method of immersing the core material in the solution for forming a coating layer; a spray method of spraying the solution for forming a coating layer to the surface of the core material; a fluidized bed method of spraying the solution for forming a coating layer to the core material that is floating by an air flow; a kneader coater method of mixing the core material of the carrier with the solution for forming a coating layer in a kneader coater and removing solvents; and the like.

The mixing ratio (mass ratio) between the toner and the carrier, represented by toner:carrier, in the two-component developer is, for example, preferably 1:100 to 30:100, and more preferably 3:100 to 20:100.

Image Forming Apparatus/Image Forming Method

The image forming apparatus/image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralizing unit that neutralizes charge by irradiating the surface of the image holder with charge neutralizing light before charging after the transfer of the toner image.

In the case of the intermediate transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing unit may be a cartridge structure (process cartridge) to be attached to and detached from the image forming apparatus. As the process cartridge, for example, a process cartridge is suitably used which includes a developing unit that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

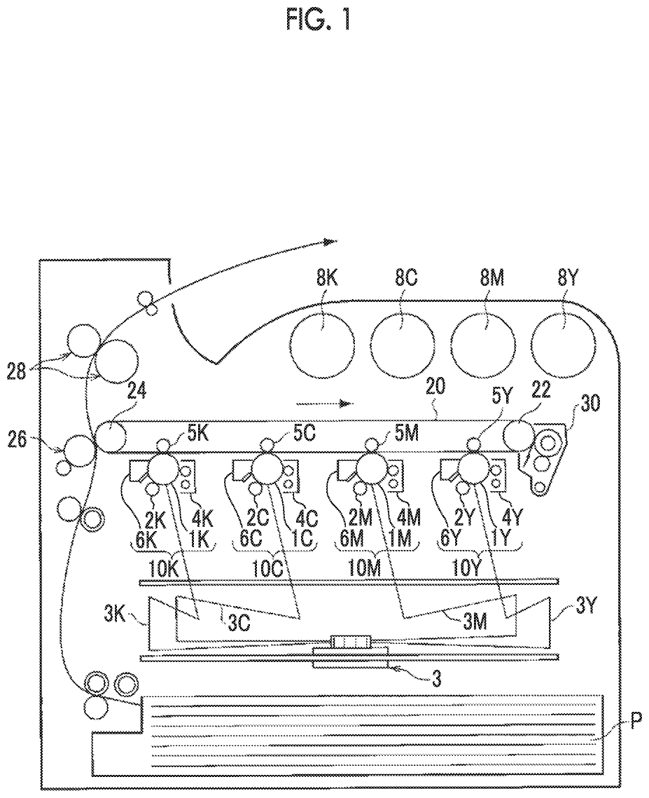

FIG. 1 is a view schematically showing the configuration of the image forming apparatus according to the present exemplary embodiment.

The image forming apparatus shown in FIG. 1 includes first to fourth image forming units 10Y, 10M, 10C, and 10K (image forming means) adopting an electrophotographic method that outputs images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 which is in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the surface of the intermediate transfer belt 20 on the image holder side.

Toners including toners of four colors, yellow, magenta, cyan, and black, stored in containers of toner cartridges 8Y, 8M, 8C, and 8K are supplied to developing devices (developing units) 4Y, 4M, 4C, and 4K of units 10Y, 10M, 10C, and 10K, respectively.

The first to fourth units 10Y, 10M, 10C, and 10K have the same configuration. Therefore, in the present specification, as a representative, the first unit 10Y will be described which is placed on the upstream side of the running direction of the intermediate transfer belt and forms a yellow image. Reference numerals marked with magenta (M), cyan (C), and black (K) instead of yellow (Y) are assigned in the same portions as those in the first unit 10Y, such that the second to fourth units 10M, 10C, and 10K will not be described again.

The first unit 10Y has a photoreceptor 1Y that acts as an image holder. Around the photoreceptor 1Y, a charging roll 2Y (an example of charging unit) that charges the surface of the photoreceptor 1Y at a predetermined potential, an exposure device 3 (an example of electrostatic charge image forming unit) that exposes the charged surface to a laser beam 3Y based on color-separated image signals to form an electrostatic charge image, a developing device 4Y (an example of developing unit) that develops the electrostatic charge image by supplying a charged toner to the electrostatic charge image, a primary transfer roll 5Y (an example of primary transfer unit) that transfers the developed toner image onto the intermediate transfer belt 20, and a photoreceptor cleaning device 6Y (an example of cleaning unit) that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ωcm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y is rotated to a predetermined development position as the photoreceptor 1Y runs. At the development position, the electrostatic charge image on the photoreceptor 1Y turns into visible image (developed image) as a toner image by the developing device 4Y

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). Then, as the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

Meanwhile, the residual toner on the photoreceptor 1Y is removed by a photoreceptor cleaning device 6Y and collected.

Furthermore, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll 26 (an example of secondary transfer unit) disposed on the image holding surface side of the intermediate transfer belt 20. Meanwhile, via a supply mechanism, recording paper P (an example of recording medium) is fed at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Then, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet and the like, in addition to the recording paper P.

In order to further improve the smoothness of the image surface after fixing, for example, it is preferable that the surface of the recording paper P be also smooth. For instance, coated paper prepared by coating the surface of plain paper with a resin or the like, art paper for printing, and the like are suitably used.

The recording paper P on which the color image has been fixed is transported to an output portion, and a series of color image forming operations is finished.

Process Cartridge/Toner Cartridge

The process cartridge according to the present exemplary embodiment will be described.

The process cartridge according to the present exemplary embodiment includes a developing unit which contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other units, such as an image holder, a charging unit, an electrostatic charge image forming unit, and a transfer unit, as necessary.

An example of the process cartridge according to the present exemplary embodiment will be shown below, but the present invention is not limited thereto. Hereinafter, among the parts shown in the drawing, main parts will be described, and others will not be described.

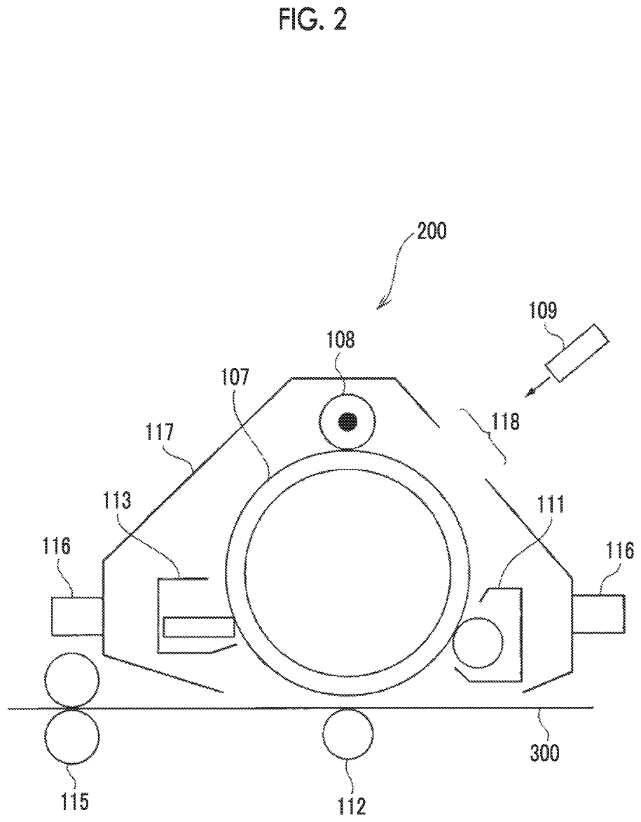

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), which are integrally combined and held in the housing 117. The process cartridge 200 forms a cartridge in this way.

In FIG. 2, 109 represents an exposure device (an example of electrostatic charge image forming unit), 112 represents a transfer device (an example of transfer unit), 115 represents a fixing device (an example of fixing unit), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing unit provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In a case where the amount of the toner contained in the container of the toner cartridge is low, the toner cartridge is replaced.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

Unless otherwise specified, synthesis, treatment, manufacturing, and the like are carried out at room temperature (25° C.±3° C.).

Synthesis of Hybrid Resin and Preparation of Resin Particle Dispersion

Hybrid Amorphous Resin (H1) and Amorphous Resin Particle Dispersion (H1)

Synthesis of Amorphous Polyester Resin P1

A four-necked flask equipped with a nitrogen introduction tube, a dehydration tube, a stirrer, and a thermocouple is cleaned out by nitrogen purging, 150 parts by mol of ethylene glycol, 84 parts by mol of terephthalic acid, and 9 parts by mol of dodecenyl succinic anhydride are added thereto, and the mixture is heated to 230° C. while being stirring in a nitrogen atmosphere and kept as it is for 4 hours. Then, the internal pressure of the flask is reduced to 9.0 kPa and kept as it is for 1 hour. The internal pressure of the flask is restored to the atmospheric pressure, then the mixture is cooled to 190° C., 5 parts by mol of fumaric acid and 2 parts by mol of trimellitic acid are added thereto, and the mixture is kept at a temperature of 190° C. for 2 hours and then heated to 205° C. for 2 hours. Thereafter, the internal pressure of the flask is reduced to 9.0 kPa and kept as it is for 3 hours, and then alcohol is distilled off, thereby obtaining an amorphous polyester resin P1.

Modification of Amorphous Polyester Resin P1 with Styrene Acryl and Preparation of Amorphous Resin Particle Dispersion H1

The amorphous polyester resin P1 (70 parts by mass) is put in a four-necked flask having an internal volume of 2 L equipped with a cooling tube, a stirrer, and a thermocouple, and the mixture is stirred in a nitrogen atmosphere at a stirring rate of 200 rpm. Then, as an addition-polymerizable monomer in a total amount of 30 parts by mass, styrene and ethyl acrylate are added thereto at a ratio of 40 parts by mol:60 parts by mol, 500 parts by mass of ethyl acetate is added thereto as a solvent, and the monomers and the solvent are mixed together for 30 minutes.

Furthermore, “NONION K-230” manufactured by NOF CORPORATION. in an amount of 12 parts in terms of conversion to an active ingredient and 233 parts of 5% potassium hydroxide are added to a total of 1,000 parts of the amorphous polyester resin P1 and the addition-polymerizable monomer, these components are melted by heating to 95° C. while being stirred and mixed together at 95° C. for 2 hours, thereby obtaining a resin mixture solution.

Then, while the resin mixture solution is being stirred, 1,145 parts of deionized water is added dropwise thereto at a rate of 6 parts/min, thereby obtaining an emulsion. Thereafter, the emulsion is cooled to 15° C., passed through a 200 mesh wire net, and deionized water is added thereto such that the concentration of solid content is adjusted to 20%, thereby obtaining an amorphous resin particle dispersion (H1) in which hybrid amorphous resin particles having a volume-average particle size of 100 nm are dispersed. The glass transition temperature of the hybrid amorphous resin (H1) is 30° C. For dispersion stabilization of the resin particle dispersion, “NONION K-230” manufactured by NOF CORPORATION. is added thereto in an amount of 8 parts in terms of conversion to an active ingredient.

Hybrid Amorphous Resin (H2) and Amorphous Resin Particle Dispersion (H2)

A hybrid amorphous resin (H2) and an amorphous resin particle dispersion (H2) are obtained in the same manner as above, except that the ratio of styrene and ethyl acrylate in the hybrid amorphous resin (H1) and the amorphous resin particle dispersion (H1) is changed to 50 parts by mol:50 parts by mol.

Synthesis of Amorphous Polyester Resin and Preparation of Amorphous Polyester Resin Particle Dispersion

Amorphous Polyester Resin (A1) and Amorphous Polyester Resin Particle Dispersion (A1)

Synthesis of Amorphous Polyester Resin (A1)
Terephthalic acid: 65 parts
Fumaric acid: 35 parts
Ethylene glycol: 40 parts
1,5-Pentanediol: 45 parts

The above materials are put in a reaction vessel including a stirrer, a nitrogen introduction tube, a temperature sensor, and a rectifying column. In a nitrogen gas stream, the temperature is raised to 220° C. for an hour, and titanium tetraethoxide is added thereto in an amount of 1 part with respect to a total of 100 parts of the above materials. While the generated water is being distilled off, the temperature is raised to 240° C. for 0.5 hours, a dehydration condensation reaction is continued for 1 hour at 240° C., and then the reactant is cooled. In this way, an amorphous polyester resin (A1) having a weight-average molecular weight of 60,000 and a glass transition temperature of 59° C. is obtained.

Preparation of Amorphous Polyester Resin Particle Dispersion (A1)

Ethyl acetate (53 parts) and 25 parts of 2-butanol are put in a vessel equipped with a temperature control unit and a nitrogen purge unit, thereby preparing a mixed solvent. Then, 100 parts of the amorphous polyester resin (A1) is slowly added to and dissolved in the solvent, a 10% aqueous ammonia solution (in an amount equivalent to 3 times the acid value of the resin in terms of molar ratio) is added thereto, and the mixed solution is stirred for 30 minutes. Thereafter, the reaction container is cleaned out by dry nitrogen purging, and in a state where the mixed solution is being stirred at a temperature kept at 40° C., 200 parts of deionized water is added dropwise thereto such that the mixed solution is emulsified. After dropwise addition ends, the emulsion is returned to 25° C., and the solvent is removed under reduced pressure, thereby obtaining a resin particle dispersion in which resin particles having a volume-average particle size of 170 nm are dispersed. Deionized water is added to the resin particle dispersion such that the concentration of solid content thereof is adjusted to 50%, thereby obtaining an amorphous polyester resin particle dispersion (A1).

Amorphous Polyester Resin (A2) and Amorphous Polyester Resin Particle Dispersion (A2)

An amorphous polyester resin (A2) and an amorphous polyester resin particle dispersion (A2) are obtained in the same manner as described above, except that in preparing the amorphous polyester resin (A1) and the amorphous polyester resin particle dispersion (A1), the dehydration condensation reaction is prolonged until the weight-average molecular weight reaches 80,000 and the glass transition temperature reaches 69° C.

Amorphous Polyester Resin (A3) and Amorphous Polyester Resin Particle Dispersion (A3)

An amorphous polyester resin (A3) and an amorphous polyester resin particle dispersion (A3) are obtained in the same manner as described above, except that in preparing the amorphous polyester resin (A1) and the amorphous polyester resin particle dispersion (A1), the dehydration condensation reaction is prolonged until the weight-average molecular weight reaches 110,000 and the glass transition temperature reaches 72° C.

Amorphous Polyester Resin (A4) and Amorphous Polyester Resin Particle Dispersion (A4)

An amorphous polyester resin (A4) and an amorphous polyester resin particle dispersion (A4) are obtained in the same manner as described above, except that in preparing the amorphous polyester resin (A1) and the amorphous polyester resin particle dispersion (A1), the temperature of the dehydration condensation reaction is changed to 210° C., and the dehydration condensation reaction is terminated at a point in time when the weight-average molecular weight has reached 50,000 and the glass transition temperature has reached 55° C.

Amorphous Polyester Resin (A5) and Amorphous Polyester Resin Particle Dispersion (A5)

An amorphous polyester resin (A5) and an amorphous polyester resin particle dispersion (A5) are obtained in the same manner as described above, except that in preparing the amorphous polyester resin (A1) and the amorphous polyester resin particle dispersion (A1), the temperature of the dehydration condensation reaction is changed to 210° C., and the dehydration condensation reaction is terminated at a point in time when the weight-average molecular weight has reached 40,000 and the glass transition temperature has reached 51° C.

Synthesis of Crystalline Polyester Resin and Preparation of Crystalline Polyester Resin Dispersion

Crystalline Polyester Resin (C1) and Crystalline Polyester Resin Dispersion (C1)

Synthesis of Crystalline Polyester Resin (C1)
1,10-Decanedicarboxylic acid: 2,600 parts
1,6-Hexanediol: 1,670 parts
Dibutyl tin oxide (catalyst): 3 parts

The above materials are put in a heat-dried reaction vessel, the air in the reaction vessel is purged with a nitrogen gas to create an inert atmosphere, and mechanical stirring is performed at 180° C. for 5 hours under reflux. Then, the temperature is slowly raised to 230° C. under reduced pressure, and the components are stirred for 2 hours. At a point in time when the components have turned viscous, the reaction system is air-cooled such that the reaction is stopped. In this way, a crystalline polyester resin (C1) having a weight-average molecular weight of 12,600 and a melting temperature of 73° C. is obtained.

Preparation of Crystalline Polyester Resin Particle Dispersion (C1)

The crystalline polyester resin (C1) (900 parts), 18 parts of “NONION K-230” manufactured by NOF CORPORATION. in an amount of 18 parts in terms of conversion to an active ingredient, and 2,100 parts of deionized water are mixed together, heated to 120° C., and dispersed using a homogenizer (ULTRA-TURRAX T50 manufactured by IKA). Then, the mixture is subjected to a dispersion treatment using a pressure jet-type Gaulin homogenizer for 1 hour, thereby obtaining a resin particle dispersion in which resin particles having a volume-average particle size of 160 nm are dispersed. Deionized water is added to the resin particle dispersion such that the amount of solid content thereof is adjusted to 35%, thereby obtaining a crystalline polyester resin particle dispersion (C1).

Preparation of Cyan Colored Particle Dispersion (PC1)
C. I. Pigment Blue 15:3 (phthalocyanine-based pigment, manufactured by Dainichiseika Color & Chemicals Mfg. Co., Ltd., cyanine blue 4937): 500 parts
“NONION K-230” manufactured by NOF CORPORATION.: 50 parts in terms of conversion to active ingredient
Deionized water: 1,930 parts

The above components are mixed together and treated with ULTIMAIZER (manufactured by SUGINO MACHINE LIMITED) at 240 MPa for 10 minutes, thereby preparing a cyan colored particle dispersion (PC1) (concentration of solid content: 20%).

Preparation of Release Agent Particle Dispersion (W1)
Paraffin wax (manufactured by NIPPON SEIRO CO., LTD., FNP92, melting temperature: 92° C.): 1,000 parts
“NONION K-230” manufactured by NOF CORPORATION.: 10 parts in terms of conversion to active ingredient
Deionized water: 3,500 parts

The above materials are mixed together, heated to 100° C., and dispersed using a homogenizer (ULTRA-TURRAX T50 manufactured by IKA). Then, by using a pressure jet-type Gaulin homogenizer, a dispersion treatment is performed, thereby obtaining a release agent particle dispersion in which release agent particles having a volume-average particle size of 220 nm are dispersed. Deionized water is added to the release agent particle dispersion such that the solid content thereof is adjusted to 20%, thereby obtaining a release agent particle dispersion (W1).

Preparation of Ionic Compound Solution

Potassium Sulfate Solution (AG1)

Potassium sulfate (4 parts) is dissolved in 96 parts of deionized water, and the pH is adjusted to 8 with potassium hydroxide, thereby preparing a potassium sulfate solution (AG1).

Ammonium Sulfate Solution (AG2)

Ammonium sulfate (4 parts) is dissolved in 96 parts of deionized water, and the pH is adjusted to 8 with potassium hydroxide, thereby preparing an ammonium sulfate solution (AG2).

Magnesium Chloride Solution (AG3)

Magnesium chloride (4 parts) is dissolved in 96 parts of deionized water, and the pH is adjusted to 8 with potassium hydroxide, thereby preparing a magnesium chloride solution (AG3).

Preparation of Nonionic Surfactant Solution

Nonionic Surfactant Solution (SN1)

Deionized water is added to a nonionic surfactant “NONION K-230” manufactured by NOF CORPORATION. to obtain a 10% dilution in terms of conversion to an active ingredient, thereby obtaining a nonionic surfactant solution (SN1).

Nonionic Surfactant Solution (SN2)

Deionized water is added to a nonionic surfactant “NONION E-212” manufactured by NOF CORPORATION. to obtain a 10% dilution in terms of conversion to an active ingredient, thereby obtaining a nonionic surfactant solution (SN2).

Preparation of Anionic Surfactant Solution

Anionic Surfactant Solution SA1

Deionized water is added to an anionic surfactant “SINOLIN SPE-1250” manufactured by New Japan Chemical Co., Ltd. to obtain a 10% dilution in terms of conversion to an active ingredient, thereby obtaining an anionic surfactant solution (SA1).

### Example 1

Preparation of Toner Particles

First Aggregation Step
Resin particle dispersion for core (hybrid amorphous resin particle dispersion (H1)): 600 parts
Crystalline polyester resin particle dispersion (C1): 59.4 parts
Cyan colored particle dispersion (PC1): 147 parts
Release agent particle dispersion (W1): 120 parts
Nonionic surfactant solution (SN1): 24 parts (2.4 parts in terms of active ingredient)
Deionized water: 400 parts

The above raw materials are put in a reactor equipped with a thermometer, a pH meter, and a stirrer, thereby preparing a raw material dispersion A for a core. Then, the raw material dispersion A for a core is moved to a polymerization tank 1 equipped with a stirrer having a stirring blade with two paddles and a thermometer, and stirred and mixed at a stirring power consumption of 0.01 (kW/m³) in a state where the temperature is being controlled to 15° C. with an ice bath and a mantle heater.

Next, 800 parts of a potassium sulfate solution (AG1), which is an ionic compound having a monovalent cation, is added dropwise to the raw material dispersion A for a core for 30 minutes, and then the raw material dispersion B for a core is heated to an aggregation temperature (the highest aggregation temperature, the same shall applies hereinafter) of 25° C. for 1 hour by using a mantle heater such that the particles are aggregated, thereby forming aggregated core particles.

During the time period between when the ionic compound has been added to the raw material dispersion A for a core in the first aggregation step and when the resin particle dispersion for a shell is added in the second aggregation step, the raw material dispersion B for a core having the viscosity shown in Table 1 is stirred at the stirring power consumption shown in Table 1.

Second Aggregation Step

Furthermore, 60 parts of the resin particle dispersion for a shell (amorphous polyester resin particle dispersion (A1)) is put in a new 2 L cylindrical stainless steel container Last (diameter 20 cm) and then moved to a polymerization tank 2 equipped with a stirrer having a stirring blade with two paddles and a thermometer, deionized water is added thereto such that the concentration of solid content shown in Table 1 is achieved, and the dispersion is stirred and mixed at a stirring power consumption of 0.3 (kW/m³) in a state where the temperature is being controlled to 20° C. with an ice bath and a mantle heater.

Then, the particle size distribution of the aggregated core particles in the polymerization tank 1 is checked using COULTER MULTISIZER II (manufactured by Beckman Coulter, Inc.), and after it is confirmed that the volume-average particle size D50v exceeds 5.4 μm, all the resin particle dispersion for a shell in the polymerization tank 2 is added dropwise to the polymerization tank 1 for 10 minutes. The mixed dispersion is heated to an aggregation temperature (that is, the highest aggregation temperature) of 32° C. by using a mantle heater such that the resin particles for a shell are aggregated with the aggregated core particles, thereby forming aggregated core particles with a shell.

Furthermore, in the second aggregation step, the mixed dispersion is stirred at the stirring power consumption shown in Table 1.

Aggregation Termination Step

After it is confirmed that the resin particles for a shell are aggregated with the aggregated core particles and the volume-average particle size D50v of the aggregated particles with a shell exceeds 5.8 μm, 150 parts of the anionic surfactant solution (SA1) is added thereto to terminate aggregation.

Coalescence Step

The aggregated particles with a shell are heated to a coalescence temperature of 85° C. for 1.0 hour and kept at 85° C. such that the particles coalesce.

After it is confirmed that the average circularity of the coalesced particles exceeds 0.960, the particles are rapidly cooled to 30° C. in 2 minutes in an ice bath.

Thereafter, the coalesced particles are sieved with a 15 μm nylon mesh to remove coarse particles, solids are separated by filtration and repeatedly washed.

How to repeatedly wash the solids is as follows. Deionized water (2,000 parts) at a temperature of 37° C. is added, and the dispersion is stirred at a stirring power consumption of 0.2 (kW/m³) such that the coalesced particles are dispersed again, an aqueous potassium hydroxide solution is added thereto until the pH reaches 9.5, and the dispersion is stirred at the same rotation speed for 10 minutes. Solids are separated by filtration, deionized water (2,000 parts) at a temperature of 37° C. is then added, the dispersion is stirred at a stirring power consumption of 0.2 (kW/m³) such that the coalesced particles are dispersed again, nitric acid is added thereto until the pH reaches 4.0, the dispersion is stirred at the same rotation speed for 10 minutes, and then solids are separated by filtration.

Thereafter, the solids are repeatedly washed once more as described above, 10,000 parts of deionized water at a temperature of 37° C. is added thereto for washing, and the solids are dried in a vacuum dryer at a temperature of 25° C., thereby obtaining toner particles (1). The volume-average particle size of the toner particles (1) is 6 μm.

Table 1 shows details of the manufacturing conditions for the toner particles of Example 1.

Preparation of Toner

The toner particles (1) (100 parts) and 3 parts of hydrophobic silica (RY50 from Nippon Aerosil Co., Ltd.) are mixed together by a sample mill at a rotation speed of 10,000 rpm for 30 seconds. The mixture is sieved with a vibration sieve having an opening size of 45 μm, thereby obtaining a toner (1).

Preparation of Carrier

Spherical magnetite powder particles (500 parts, volume-average particle size 0.55 km) are with a Henschel mixer, 5 parts of a titanate-based coupling agent is then added thereto, and the mixture is heated to 100° C. and stirred for 30 minutes. Next, 6.25 parts of phenol, 9.25 parts of 35% formalin, 500 parts of magnetite particles treated with a titanate-based coupling agent, 6.25 parts of 25% aqueous ammonia, and 425 parts of water are put in a four-necked flask and stirred, and reacted at 85° C. for 120 minutes while being stirred. Thereafter, the reaction solution is cooled to 25° C., 500 parts of water is added thereto, the supernatant is removed, and the precipitate is washed with water. The precipitate washed with water is heated under reduced pressure and dried, thereby obtaining a carrier (CA) having an average particle size of 35 km.

Preparation of Developer

The toner (1) and the carrier (CA) are put in a V blender at a ratio of toner (1):carrier (CA)=5:95 (mass ratio) and stirred for 20 minutes, thereby obtaining a developer (1).

### Example 2

Toner particles, a toner, and a developer are obtained in the same manner as in Example 1, except that the resin particle dispersion H1 for a core of the raw material dispersion A for a core is changed to the resin particle dispersion H2 for a core.

### Examples 3 to 6

Toner particles, a toner, and a developer are obtained in the same manner as in Example 1, except that the aggregation temperature in the first aggregation step is changed to the temperature shown in Table 1.

### Examples 7 to 10

Toner particles, a toner, and a developer are obtained in the same manner as in Example 1, except that the aggregation temperatures in the first aggregation step and the second aggregation step are changed to the temperatures shown in Table 1.

### Examples 11 to 13

Toner particles, a toner, and a developer are obtained in the same manner as in Example 1, except that the coalescence temperature in the coalescence step is changed to the temperature shown in Table 1.

### Examples 14 to 17, 28, and 29

Toner particles, a toner, and a developer are obtained in the same manner as in Example 1, except that the type of resin particle dispersion for a shell is changed as shown in Table 1.

### Example 18

Toner particles, a toner, and a developer are obtained in the same manner as in Example 1, except that the amount of the resin particle dispersion for a shell added is changed to 96 parts from 60 parts.

### Example 19

Toner particles, a toner, and a developer are obtained in the same manner as in Example 1, except that the amount of the resin particle dispersion for a shell is changed to 108 parts from 60 parts.

### Examples 20 to 25

Toner particles, a toner, and a developer are obtained in the same manner as in Example 1, except that the amount deionized water is changed such that the aggregated core particle dispersion A and the resin particle dispersion for a shell have the concentration of solid content shown in Table 1.

### Example 26

Toner particles, a toner, and a developer are obtained in the same manner as in Example 1, except that the amount of deionized water in the raw material dispersion A for a core is changed to 35 parts from 400 parts, and a thickener “carboxymethyl cellulose (CMC)” is added until the viscosity of the raw material dispersion B for a core reaches the viscosity in Table 1 after the addition of the ionic compound solution AG1.

### Example 27

Toner particles, a toner, and a developer are obtained in the same manner as in Example 1, except that the amount of deionized water in the raw material dispersion A for a core is changed to 5 parts from 400 parts, and a thickener “carboxymethyl cellulose (CMC)” is added until the viscosity of the raw material dispersion B for a core reaches the viscosity in Table 1 after the addition of the ionic compound solution AG1.

### Examples 30 to 33

Toner particles, a toner, and a developer are obtained in the same manner as in Example 1, except that in stirring the raw material dispersion B for a core in the first aggregation step, the rotation speed for stirring is controlled such that the stirring power consumption becomes the value shown in Table 1.

### Example 34

Toner particles, a toner, and a developer are obtained in the same manner as in Example 1, except that the type and amount of raw materials and the conditions of steps are changed by the same method as in Examples 2 to 33 such that the conditions shown in Table 1 are created.

### Example 35

Toner particles, a toner, and a developer are obtained in the same manner as in Example 1, except that the ionic compound added in the first aggregation step is changed to the ammonium sulfate solution AG2 (600 parts) from the potassium sulfate solution AG1 (800 parts).

### Comparative Example 1

Toner particles, a toner, and a developer are obtained in the same manner as in Example 1, except that the aggregation temperature in the first aggregation step is changed to the temperature shown in Table 1.

### Comparative Example 2

Toner particles, a toner, and a developer are obtained in the same manner as in Example 1, except that the coalescence temperature in the coalescence step is changed to the temperature shown in Table 1.

### Comparative Example 3

Toner particles, a toner, and a developer are obtained in the same manner as in Example 1, except that “NONION K-230 (8 parts in terms of conversion to an active ingredient) added to dispersion stabilization of the amorphous resin particle dispersion (H1) is changed to “NONION E-212 (8 parts in terms of conversion to an active ingredient)” manufactured by NOF CORPORATION., 24 parts of the nonionic surfactant solution (SN1) added in the first aggregation step is changed to 24 parts of the nonionic surfactant solution (SN2), and the coalescence temperature of the coalescence step is set to the temperature in Table 1.

### Comparative Example 4

Toner particles, a toner, and a developer are obtained in the same manner as in Example 1, except that “NONION K-230 (8 parts in terms of conversion to an active ingredient) added to dispersion stabilization of the amorphous resin particle dispersion (H1) is changed to “SINOLIN SPE-1250 (8 parts in terms of conversion to an active ingredient)” manufactured by New Japan Chemical Co., Ltd., and 24 parts of the nonionic surfactant solution (SN1) added in the first aggregation step is changed to 24 parts of the Anionic surfactant solution (SA1).

### Comparative Example 5

Toner particles, a toner, and a developer are obtained in the same manner as in Example 1, except that the ionic compound added in the first aggregation step is changed to 150 parts of the magnesium chloride solution (AG3) from 800 parts of the potassium sulfate solution (AG1).

Evaluation of Gloss Unevenness

The developer of each sample is filled into all the developing machines of six engines of an image forming apparatus (“Revoria Press PC1120” manufactured by FUJIFILM Business Innovation Corp.).

By using this image forming apparatus, a 24 g/m solid image composed of six layers of the developer in an amount of 4.0 g/m² from the engines is formed on an OHP film (OHP film clear A4 for PPC laser manufactured by FUJIFILM Business Innovation Corp.).

The image is continuously printed on 100,000 sheets at 15° C., a humidity of 95% RH, a fixing temperature of 180° C. (pressure roll temperature of 100° C.), and a speed of 120 sheets/min. By using a gloss meter GM-26D (manufactured by MURAKAMI COLOR RESEARCH LABORATORY CO., LTD.), the luster (hereinafter, also referred to as gloss) of the printed solid image is measured under the condition of an incident light angle of 600 to the image.

The gloss is measured at 9 sites where three lines, which are parallel to the transverse direction of the OHP film and at positions 5 cm, 15 cm, and 25 cm distant from one longitudinal end of the OHP film, and three lines, which are parallel to the longitudinal direction of the OHP film and at positions 4 cm, 10.5 cm, and 17 cm distant from one transverse end of the OHP film, meet at right angles.

The standard deviation of the gloss measured at the 9 sites is calculated. The smaller the standard deviation, the smaller the gloss unevenness. Then, the gloss unevenness is evaluated based on the following standard.
A: The standard deviation is less than 0.3 (gloss unevenness does not occur).
B: The standard deviation is 0.3 or more and less than 0.6 (gloss unevenness substantially is not observed).
C: The standard deviation is 0.6 or more and 1.0 or less (gloss unevenness is noticed when being closely observed).
D: The standard deviation is 1.0 or more and less than 1.5 (gloss unevenness is not noticed by visual observation)
E: The standard deviation is 1.5 or more and less than 2.0 (gloss unevenness is unproblematic for practical use).
F: The standard deviation is more than 2.0 (gloss unevenness is clearly noticeable).

Details of the description in Table 1 are as follows.
Resin particle Tgc in the column of Resin particle dispersion for core: glass transition temperature of resin particles for a core
Resin particle Tgs in the column of Resin particle dispersion for shell: glass transition temperature of resin particles for a shell
Resin particle SP value c in the column of Resin particle dispersion for core: solubility parameter of resin particles for a core
Resin particle SP value s in the column of Resin particle dispersion for shell: solubility parameter of resin particles for a shell
Viscosity of raw material dispersion B for core: viscosity of raw material dispersion B for a core at 25° C. and a shear rate of 1/s
Stirring power consumption in the column of First aggregation step: stirring power consumption per unit volume of the raw material dispersion B for a core
Stirring power consumption in the column of Second aggregation step: stirring power consumption per unit volume of the mixed dispersion
Amount of resin particles in the column of Resin particle dispersion for shell: exterior attachment ratio of resin particles for a shell to resin particles for a core (exterior attachment ratio=resin particle for shell/amount of resin particle for core×100)

The dew point of “NONION K-230” as a nonionic surfactant manufactured by NOF CORPORATION. is “>100° C.”.

The dew point of “NONION e-212” as a nonionic surfactant manufactured by NOF CORPORATION. is 92° C.

Regarding the dew point of a surfactant, “>100° C.” means that turbidness does not occur even though the surfactant is heated to 100° C. at the time of measuring the cloud point.

TABLE 1-1

| | First aggregation step | | | | | |
|---|---|---|---|---|---|---|
| | Raw material dispersion A for core | | | | | |
| | Resin particle dispersion for core | | | Surfactant of resin particle dispersion for | | |
| | | Resin particles | Resin particles | core and raw material dispersion for core | | |
| | Type | Tgc | SP value c | Type | Dew point | Amount |
| | — | ° C. | — | — | ° C. | — |
| Example 1 | H1 | 30 | 9.8 | SN1 (nonionic) | >100° C. | 4 |
| Example 2 | H2 | 39 | 9.5 | SN1 (nonionic) | >100° C. | 4 |
| Example 3 | H1 | 30 | 9.8 | SN1 (nonionic) | >100° C. | 4 |
| Example 4 | H1 | 30 | 9.8 | SN1 (nonionic) | >100° C. | 4 |
| Example 5 | H1 | 30 | 9.8 | SN1 (nonionic) | >100° C. | 4 |
| Example 6 | H1 | 30 | 9.8 | SN1 (nonionic) | >100° C. | 4 |
| Example 7 | H1 | 30 | 9.8 | SN1 (nonionic) | >100° C. | 4 |
| Example 8 | H1 | 30 | 9.8 | SN1 (nonionic) | >100° C. | 4 |
| Example 9 | H1 | 30 | 9.8 | SN1 (nonionic) | >100° C. | 4 |
| Example 10 | H1 | 30 | 9.8 | SN1 (nonionic) | >100° C. | 4 |
| Example 11 | H1 | 30 | 9.8 | SN1 (nonionic) | >100° C. | 4 |
| Example 12 | H1 | 30 | 9.8 | SN1 (nonionic) | >100° C. | 4 |
| Example 13 | H1 | 30 | 9.8 | SN1 (nonionic) | >100° C. | 4 |
| Example 14 | H1 | 30 | 9.8 | SN1 (nonionic) | >100° C. | 4 |
| Example 15 | H1 | 30 | 9.8 | SN1 (nonionic) | >100° C. | 4 |
| Example 16 | H1 | 30 | 9.8 | SN1 (nonionic) | >100° C. | 4 |
| Example 17 | H1 | 30 | 9.8 | SN1 (nonionic) | >100° C. | 4 |
| Example 18 | H1 | 30 | 9.8 | SN1 (nonionic) | >100° C. | 4 |
| Example 19 | H1 | 30 | 9.8 | SN1 (nonionic) | >100° C. | 4 |
| Example 20 | H1 | 30 | 9.8 | SN1 (nonionic) | >100° C. | 4 |
| Example 21 | H1 | 30 | 9.8 | SN1 (nonionic) | >100° C. | 4 |
| Example 22 | H1 | 30 | 9.8 | SN1 (nonionic) | >100° C. | 4 |
| Example 23 | H1 | 30 | 9.8 | SN1 (nonionic) | >100° C. | 4 |
| Example 24 | H1 | 30 | 9.8 | SN1 (nonionic) | >100° C. | 4 |
| Example 25 | H1 | 30 | 9.8 | SN1 (nonionic) | >100° C. | 4 |
| Example 26 | H1 | 30 | 9.8 | SN1 (nonionic) | >100° C. | 4 |
| Example 27 | H1 | 30 | 9.8 | SN1 (nonionic) | >100° C. | 4 |
| Example 28 | H2 | 39 | 9.5 | SN1 (nonionic) | >100° C. | 4 |
| Example 29 | H2 | 39 | 9.5 | SN1 (nonionic) | >100° C. | 4 |
| Example 30 | H1 | 30 | 9.8 | SN1 (nonionic) | >100° C. | 4 |
| Example 31 | H1 | 30 | 9.8 | SN1 (nonionic) | >100° C. | 4 |
| Example 32 | H1 | 30 | 9.8 | SN1 (nonionic) | >100° C. | 4 |
| Example 33 | H1 | 30 | 9.8 | SN1 (nonionic) | >100° C. | 4 |
| Example 34 | H1 | 30 | 9.8 | SN1 (nonionic) | >100° C. | 4 |
| Example 35 | H1 | 30 | 9.8 | SN1 (nonionic) | >100° C. | 4 |
| Comparative | H1 | 30 | 9.8 | SN1 (nonionic) | >100° C. | 4 |
| Example 1 | | | | | | |
| Comparative | H1 | 30 | 9.8 | SN1 (nonionic) | >100° C. | 4 |
| Example 2 | | | | | | |
| Comparative | H1 | 30 | 9.8 | SN2 (nonionic/ | 92 | 4 |
| Example 3 | | | | low cloud point) | | |
| Comparative | H1 | 30 | 9.8 | SA1 (anionic) | N/A | 4 |
| Example 4 | | | | | | |
| Comparative | H1 | 30 | 9.8 | SN1 (nonionic) | >100° C. | 4 |
| Example 5 | | | | | | |

| | First aggregation step | | | | |
|---|---|---|---|---|---|
| | | Raw material | | | |
| | Ionic | dispersion B | Highest | | Concentration of solid |
| | compound | for core | aggregation | Stirring power | content Cc of aggregated |
| | Type | Viscosity | temperature | consumption | core particle dispersion |
| | — | Pa · s | ° C. | kW/m³ | % by mass |
| Example 1 | AG1 | 9 | 25 | 0.01 to 2 | 15 |
| Example 2 | AG1 | 8 | 25 | 0.01 to 2 | 15 |
| Example 3 | AG1 | 9 | 12 | 0.01 to 2 | 15 |
| Example 4 | AG1 | 9 | 15 | 0.01 to 2 | 15 |
| Example 5 | AG1 | 9 | 27 | 0.01 to 2 | 15 |
| Example 6 | AG1 | 9 | 29 | 0.01 to 2 | 15 |
| Example 7 | AG1 | 9 | 18 | 0.01 to 2 | 15 |
| Example 8 | AG1 | 9 | 19 | 0.01 to 2 | 15 |
| Example 9 | AG1 | 9 | 25 | 0.01 to 2 | 15 |
| Example 10 | AG1 | 9 | 25 | 0.01 to 2 | 15 |
| Example 11 | AG1 | 9 | 25 | 0.01 to 2 | 15 |
| Example 12 | AG1 | 9 | 25 | 0.01 to 2 | 15 |
| Example 13 | AG1 | 9 | 25 | 0.01 to 2 | 15 |
| Example 14 | AG1 | 9 | 25 | 0.01 to 2 | 15 |
| Example 15 | AG1 | 9 | 25 | 0.01 to 2 | 15 |
| Example 16 | AG1 | 9 | 25 | 0.01 to 2 | 15 |
| Example 17 | AG1 | 9 | 25 | 0.01 to 2 | 15 |
| Example 18 | AG1 | 9 | 25 | 0.01 to 2 | 15 |
| Example 19 | AG1 | 9 | 25 | 0.01 to 2 | 15 |
| Example 20 | AG1 | 9 | 25 | 0.01 to 2 | 15 |
| Example 21 | AG1 | 9 | 25 | 0.01 to 2 | 15 |
| Example 22 | AG1 | 7 | 25 | 0.01 to 2 | 10 |
| Example 23 | AG1 | 5 | 25 | 0.01 to 2 | 7 |
| Example 24 | AG1 | 0.5 | 25 | 0.01 to 2 | 1.5 |
| Example 25 | AG1 | 1 | 25 | 0.01 to 2 | 2 |
| Example 26 | AG1 | 95 (addition | 25 | 0.01 to 9 | 20 |
| | | of thickener) | | | |
| Example 27 | AG1 | 102 (addition | 25 | 0.01 to 9 | 21 |
| | | of thickener) | | | |
| Example 28 | AG1 | 9 | 25 | 0.01 to 2 | 15 |
| Example 29 | AG1 | 9 | 25 | 0.01 to 2 | 15 |
| Example 30 | AG1 | 9 | 25 | 0.007 | 15 |
| Example 31 | AG1 | 9 | 25 | 0.01 to 2 | 15 |
| Example 32 | AG1 | 9 | 25 | 0.01 to 8 | 15 |
| Example 33 | AG1 | 9 | 25 | 0.01 to 10 | 15 |
| Example 34 | AG1 | 0.5 | 29 | 1 to 10 | 1.5 |
| Example 35 | AG2 | 9 | 25 | 0.01 to 2 | 15 |
| Comparative | AG1 | 9 | 34 | 0.01 to 2 | 15 |
| Example 1 | | | | | |
| Comparative | AG1 | 9 | 25 | 0.01 to 2 | 15 |
| Example 2 | | | | | |
| Comparative | AG1 | 9 | 25 | 0.01 to 2 | 15 |
| Example 3 | | | | | |
| Comparative | AG1 | 9 | 25 | 0.01 to 2 | 15 |
| Example 4 | | | | | |
| Comparative | AG3 (Mg | 20 | 25 | 0.01 to 2 | 15 |
| Example 5 | chloride) | | | | |

| | Second aggregation step | | | | | | | |
|---|---|---|---|---|---|---|---|---|
| | Resin particle dispersion for shell | | | | | | | |
| | | Resin | Resin | Resin | Concentration | | | |
| | | particles | particles | particles | of solid | Tgs − | SP value s − | |
| | Type | Tgs | SP value s | Amount | content Cs | Tgc | SP value c | Cs − Cc |
| | − | ° C. | − | % by mass | % by mass | ° C. | − | % by mass |
| Example 1 | A1 | 59 | 10.5 | 25 | 30 | 29 | 0.7 | 15 |
| Example 2 | A1 | 59 | 10.5 | 25 | 30 | 20 | 1 | 15 |
| Example 3 | A1 | 59 | 10.5 | 25 | 30 | 29 | 0.7 | 15 |
| Example 4 | A1 | 59 | 10.5 | 25 | 30 | 29 | 0.7 | 15 |
| Example 5 | A1 | 59 | 10.5 | 25 | 30 | 29 | 0.7 | 15 |
| Example 6 | A1 | 59 | 10.5 | 25 | 30 | 29 | 0.7 | 15 |
| Example 7 | A1 | 59 | 10.5 | 25 | 30 | 29 | 0.7 | 15 |
| Example 8 | A1 | 59 | 10.5 | 25 | 30 | 29 | 0.7 | 15 |
| Example 9 | A1 | 59 | 10.5 | 25 | 30 | 29 | 0.7 | 15 |
| Example 10 | A1 | 59 | 10.5 | 25 | 30 | 29 | 0.7 | 15 |
| Example 11 | A1 | 59 | 10.5 | 25 | 30 | 29 | 0.7 | 15 |
| Example 12 | A1 | 59 | 10.5 | 25 | 30 | 29 | 0.7 | 15 |
| Example 13 | A1 | 59 | 10.5 | 25 | 30 | 29 | 0.7 | 15 |
| Example 14 | H1 | 30 | 9.8 | 25 | 30 | 0 | 0 | 15 |
| Example 15 | H2 | 39 | 10.5 | 25 | 30 | 9 | 0.7 | 15 |
| Example 16 | A2 | 69 | 10.5 | 25 | 30 | 39 | 0.7 | 15 |
| Example 17 | A3 | 72 | 10.5 | 25 | 30 | 42 | 0.7 | 15 |
| Example 18 | A1 | 59 | 10.5 | 40 | 30 | 29 | 0.7 | 15 |
| Example 19 | A1 | 59 | 10.5 | 45 | 30 | 29 | 0.7 | 15 |
| Example 20 | A1 | 59 | 10.5 | 25 | 16 | 29 | 0.7 | 1 |
| Example 21 | A1 | 59 | 10.5 | 25 | 17 | 29 | 0.7 | 2 |
| Example 22 | A1 | 59 | 10.5 | 25 | 50 | 29 | 0.7 | 40 |
| Example 23 | A1 | 59 | 10.5 | 25 | 50 | 29 | 0.7 | 43 |
| Example 24 | A1 | 59 | 10.5 | 25 | 30 | 29 | 0.7 | 28.5 |
| Example 25 | A1 | 59 | 10.5 | 25 | 30 | 29 | 0.7 | 28 |
| Example 26 | A1 | 59 | 10.5 | 25 | 30 | 29 | 0.7 | 10 |
| Example 27 | A1 | 59 | 10.5 | 25 | 30 | 29 | 0.7 | 9 |
| Example 28 | A4 | 55 | 11 | 25 | 30 | 16 | 1.5 | 15 |
| Example 29 | A5 | 51 | 11.5 | 25 | 30 | 12 | 2 | 15 |
| Example 30 | A1 | 59 | 10.5 | 25 | 30 | 29 | 0.7 | 15 |
| Example 31 | A1 | 59 | 10.5 | 25 | 30 | 29 | 0.7 | 15 |
| Example 32 | A1 | 59 | 10.5 | 25 | 30 | 29 | 0.7 | 15 |
| Example 33 | A1 | 59 | 10.5 | 25 | 30 | 29 | 0.7 | 15 |
| Example 34 | A5 | 51 | 11.5 | 25 | 16 | 21 | 1.7 | 14.5 |
| Example 35 | A1 | 59 | 10.5 | 25 | 30 | 29 | 0.7 | 15 |
| Comparative | A1 | 59 | 10.5 | 25 | 30 | 29 | 0.7 | 15 |
| Example 1 | | | | | | | | |
| Comparative | A1 | 59 | 10.5 | 25 | 30 | 29 | 0.7 | 15 |
| Example 2 | | | | | | | | |
| Comparative | A1 | 59 | 10.5 | 25 | 30 | 29 | 0.7 | 15 |
| Example 3 | | | | | | | | |
| Comparative | A1 | 59 | 10.5 | 25 | 30 | 29 | 0.7 | 15 |
| Example 4 | | | | | | | | |
| Comparative | A1 | 59 | 10.5 | 25 | 30 | 29 | 0.7 | 15 |
| Example 5 | | | | | | | | |

| | Second aggregation step | | Coalescence step | | |
|---|---|---|---|---|---|
| | Highest | | | Internal | |
| | aggregation | Stirring power | Coalescence | porosity of | |
| | temperature | consumption | temperature | toner particles | Evaluation |
| | ° C. | kW/m³ | ° C. | % | Gloss unevenness |
| Example 1 | 32 | 0.02 to 5 | 85 | 3 | A |
| Example 2 | 32 | 0.02 to 5 | 85 | 4 | B (although internal pores are few, |
| | | | | | slight gloss unevenness occurs due |
| | | | | | to low temperature fixability) |
| Example 3 | 32 | 0.02 to 5 | 85 | 5 | C |
| Example 4 | 32 | 0.02 to 5 | 85 | 4 | A |
| Example 5 | 32 | 0.02 to 5 | 85 | 4 | A |
| Example 6 | 32 | 0.02 to 5 | 85 | 5 | C |
| Example 7 | 18 | 0.02 to 5 | 85 | 4 | A |
| Example 8 | 19 | 0.02 to 5 | 85 | 4 | A |
| Example 9 | 56 | 0.02 to 5 | 85 | 4 | A |
| Example 10 | 58 | 0.02 to 5 | 85 | 4 | A |
| Example 11 | 32 | 0.02 to 5 | 65 | 5 | C |
| Example 12 | 32 | 0.02 to 5 | 75 | 4 | A |
| Example 13 | 32 | 0.02 to 5 | 100 | 2 | A |
| Example 14 | 32 | 0.02 to 5 | 85 | 5 | C |
| Example 15 | 32 | 0.02 to 5 | 85 | 5 | C |
| Example 16 | 32 | 0.02 to 5 | 85 | 5 | C |
| Example 17 | 32 | 0.02 to 5 | 85 | 5 | C |
| Example 18 | 32 | 0.02 to 5 | 85 | 4 | B (although internal pores are few, |
| | | | | | slight gloss unevenness occurs due |
| | | | | | to low temperature fixability) |
| Example 19 | 32 | 0.02 to 5 | 85 | 4 | C (although internal pores are few, |
| | | | | | gloss unevenness occurs due to |
| | | | | | low temperature fixability) |
| Example 20 | 32 | 0.02 to 5 | 85 | 5 | C |
| Example 21 | 32 | 0.02 to 5 | 85 | 4 | A |
| Example 22 | 32 | 0.02 to 5 | 85 | 4 | A |
| Example 23 | 32 | 0.02 to 5 | 85 | 6 | C |
| Example 24 | 32 | 0.02 to 5 | 85 | 7 | C |
| Example 25 | 32 | 0.02 to 5 | 85 | 5 | C |
| Example 26 | 32 | 0.02 to 5 | 85 | 7 | C |
| Example 27 | 32 | 0.02 to 5 | 85 | 8 | D |
| Example 28 | 32 | 0.02 to 5 | 85 | 6 | C |
| Example 29 | 32 | 0.02 to 5 | 85 | 8 | D |
| Example 30 | 32 | 0.02 to 5 | 85 | 7 | C |
| Example 31 | 32 | 0.02 to 5 | 85 | 5 | C |
| Example 32 | 32 | 0.02 to 5 | 85 | 5 | C |
| Example 33 | 32 | 0.02 to 5 | 85 | 7 | C |
| Example 34 | 19 | 0.02 to 5 | 65 | 10 | D |
| Example 35 | 32 | 0.02 to 5 | 85 | 3 | A |
| Comparative | 32 | 0.02 to 5 | 85 | 14 | F |
| Example 1 | | | | | |
| Comparative | 32 | 0.02 to 5 | 55 | 18 | F |
| Example 2 | | | | | |
| Comparative | 32 | 0.02 to 5 | 95 | 10 | E |
| Example 3 | | | | | |
| Comparative | 32 | 0.02 to 5 | 85 | 10 | E |
| Example 4 | | | | | |
| Comparative | 32 | 0.02 to 5 | 85 | 15 | F |
| Example 5 | | | | | |

The above results tell that the toners obtained in the present examples further suppress gloss unevenness, compared to the toners obtained in comparative examples.

The present exemplary embodiment includes the following aspects.
(((1)))
A manufacturing method of an electrostatic charge image developing toner comprising: first aggregation of aggregating resin particles for a core in a raw material dispersion B for a core at an aggregation temperature equal to or lower than a glass transition temperature Tg of the resin particles for a core to form aggregated core particles, the raw material dispersion B for a core being obtained by adding an ionic compound having a monovalent cation to a raw material dispersion A for a core, that contains the resin particles for a core having a glass transition temperature lower than 40° C. and having an ester structure, a nonionic surfactant, and an aqueous medium;
second aggregation of mixing an aggregated core particle dispersion containing the aggregated core particles and the aqueous medium with a resin particle dispersion for a shell containing resin particles for a shell having an ester structure and an aqueous medium, and aggregating the resin particles for a shell with the resin particles for a core in a mixed dispersion containing the aggregated core particles and the resin particles for a shell at an aggregation temperature equal to or lower than a glass transition temperature Tg of the resin particles for a shell to form aggregated core particles with a shell; and
coalescence of coalescing the aggregated core particles with a shell at a coalescence temperature that is equal to or higher than the glass transition temperatures of the resin particles for a core and the resin particles for a shell and lower than a cloud point of the nonionic surfactant.
(((2)))
The manufacturing method of an electrostatic charge image developing toner according to (((1))), wherein the glass transition temperature of the resin particles for a shell is higher than the glass transition temperature of the resin particles for a core.
(((3)))
The manufacturing method of an electrostatic charge image developing toner according to (((2))), wherein a difference in the glass transition temperature between the resin particles for a shell and the resin particles for a core is 1° C. or higher and 40° C. or lower.
(((4)))
The manufacturing method of an electrostatic charge image developing toner according to (((2))) or (((3))), wherein the glass transition temperature of the resin particles for a shell is 40° C. or higher and 70° C. or lower.
(((5)))
The manufacturing method of an electrostatic charge image developing toner according to any one of (((1))) to (((4))), wherein an amount of the resin particles for a shell is 40% by mass or less with respect to the resin particles for a core.
(((6)))
The manufacturing method of an electrostatic charge image developing toner according to any one of (((1))) to (((5))), wherein a concentration of solid content of the resin particle dispersion for a shell is higher than a concentration of solid content of the aggregated core particle dispersion.
(((7)))
The manufacturing method of an electrostatic charge image developing toner according to any one of (((1))) to (((6))), wherein a difference between a concentration of solid content of the resin particle dispersion for a shell and a concentration of solid content of the aggregated core particle dispersion is 2% by mass or more and 40% by mass or less.
(((8)))
The manufacturing method of an electrostatic charge image developing toner according to any one of (((1))) to (((7))), wherein a concentration of solid content of the aggregated core particle dispersion is 2% by mass or more and 20% by mass or less.
(((9)))
The manufacturing method of an electrostatic charge image developing toner according to any one of (((1))) to (((8))), wherein an absolute value of a difference in a solubility parameter between the resin particles for a core and the resin particles for a shell is 0 or more and 1.5 or less.
(((10)))
The manufacturing method of an electrostatic charge image developing toner according to any one of (((1))) to (((9))), wherein in the first aggregation, the resin particles for a core are aggregated in a state where the raw material dispersion B for a core is being stirred at a stirring power consumption of 0.01 kW/m³ or more and 9.0 kW/m³ or less per unit volume of the raw material dispersion B for a core to which the ionic compound having a monovalent cation is added.
(((11)))
The manufacturing method of an electrostatic charge image developing toner according to any one of (((1))) to (((10))), wherein a viscosity of the raw material dispersion B for a core to, which the ionic compound having a monovalent cation is added, during stirring at 25° C. and a shear rate of 1/s is 1 Pa·s or more and 100 Pa·s or less.
(((12)))
The manufacturing method of an electrostatic charge image developing toner according to any one of (((1))) to (((11))), wherein in the first aggregation, the aggregation temperature is equal to or higher than (the glass transition temperature of the resin particles for a core−15° C.) and equal to or lower than (the glass transition temperature of the resin particles for a core−3° C.).
(((13)))
The manufacturing method of an electrostatic charge image developing toner according to any one of (((1))) to (((13))), wherein in the second aggregation, the aggregation temperature is equal to or higher than (the glass transition temperature of the resin particles for a shell−40° C.) and equal to or lower than (the glass transition temperature of the resin particles for a shell−3° C.).
(((14)))
The manufacturing method of an electrostatic charge image developing toner according to any one of (((1))) to (((13))), wherein the raw material dispersion A for a core is obtained using a resin particle dispersion for a core containing the resin particles for a core, the nonionic surfactant, and the aqueous medium.
(((15)))
The manufacturing method of an electrostatic charge image developing toner according to any one of (((1))) to (((14))), wherein in the coalescence, the aggregated core particles with a shell are coalesced until an internal porosity of obtained toner particles is 5% or less.
(((16)))
The manufacturing method of an electrostatic charge image developing toner according to any one of (((1))) to (((15))), wherein in the coalescence, the coalescence temperature is 75° C. or higher and 100° C. or lower.
(((17)))
The manufacturing method of an electrostatic charge image developing toner according to (((4))), wherein in the coalescence, the coalescence temperature is 75° C. or higher and 100° C. or lower.
(((18)))
The manufacturing method of an electrostatic charge image developing toner according to (((8))), wherein in the first aggregation, the resin particles for a core are aggregated in a state where the raw material dispersion B for a core is being stirred at a stirring power consumption of 0.01 kW/m³ or more and 9.0 kW/m³ or less per unit volume of the raw material dispersion B for a core to which the ionic compound having a monovalent cation is added.
(((19)))
The manufacturing method of an electrostatic charge image developing toner according to (((10))), wherein a viscosity of the raw material dispersion B for a core, to which the ionic compound having a monovalent cation is added, at 25° C. and a shear rate of 1/s is 1 Pa·s or more and 100 Pa·s or less.
(((20)))
The manufacturing method of an electrostatic charge image developing toner according to (((15))), wherein in the coalescence, the coalescence temperature is 75° C. or higher and 100° C. or lower.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A manufacturing method of an electrostatic charge image developing toner, comprising:
first aggregation of aggregating resin particles for a core in a raw material dispersion B for a core at an aggregation temperature equal to or lower than a glass transition temperature Tg of the resin particles for a core to form aggregated core particles, the raw material dispersion B for a core being obtained by adding an ionic compound having a monovalent cation to a raw material dispersion A for a core, that contains the resin particles for a core having a glass transition temperature lower than 40° C. and having an ester structure, a nonionic surfactant, and an aqueous medium;
second aggregation of mixing an aggregated core particle dispersion containing the aggregated core particles and the aqueous medium with a resin particle dispersion for a shell containing resin particles for a shell having an ester structure and an aqueous medium, and aggregating the resin particles for a shell with the resin particles for a core in a mixed dispersion containing the aggregated core particles and the resin particles for a shell at an aggregation temperature equal to or lower than a glass transition temperature Tg of the resin particles for a shell to form aggregated core particles with a shell; and
coalescence of coalescing the aggregated core particles with a shell at a coalescence temperature that is equal to or higher than the glass transition temperatures of the resin particles for a core and the resin particles for a shell and lower than a cloud point of the nonionic surfactant.

2. The manufacturing method of an electrostatic charge image developing toner according to claim 1,
wherein the glass transition temperature of the resin particles for a shell is higher than the glass transition temperature of the resin particles for a core.

3. The manufacturing method of an electrostatic charge image developing toner according to claim 2,
wherein a difference in the glass transition temperature between the resin particles for a shell and the resin particles for a core is 1° C. or higher and 40° C. or lower.

4. The manufacturing method of an electrostatic charge image developing toner according to claim 2,
wherein the glass transition temperature of the resin particles for a shell is 40° C. or higher and 70° C. or lower.

5. The manufacturing method of an electrostatic charge image developing toner according to claim 2,
wherein an amount of the resin particles for a shell is 40% by mass or less with respect to the resin particles for a core.

6. The manufacturing method of an electrostatic charge image developing toner according to claim 1,
wherein a concentration of solid content of the resin particle dispersion for a shell is higher than a concentration of solid content of the aggregated core particle dispersion.

7. The manufacturing method of an electrostatic charge image developing toner according to claim 1,
wherein a difference between a concentration of solid content of the resin particle dispersion for a shell and a concentration of solid content of the aggregated core particle dispersion is 2% by mass or more and 40% by mass or less.

8. The manufacturing method of an electrostatic charge image developing toner according to claim 1,
wherein a concentration of solid content of the aggregated core particle dispersion is 2% by mass or more and 20% by mass or less.

9. The manufacturing method of an electrostatic charge image developing toner according to claim 1,
wherein an absolute value of a difference in a solubility parameter between the resin particles for a core and the resin particles for a shell is 0 or more and 1.5 or less.

10. The manufacturing method of an electrostatic charge image developing toner according to claim 1,
wherein in the first aggregation, the resin particles for a core are aggregated in a state where the raw material dispersion B for a core is being stirred at a stirring power consumption of 0.01 kW/m³ or more and 9.0 kW/m³ or less per unit volume of the raw material dispersion B for a core to which the ionic compound having a monovalent cation is added.

11. The manufacturing method of an electrostatic charge image developing toner according to claim 1,
wherein a viscosity of the raw material dispersion B for a core, to which the ionic compound having a monovalent cation is added, during stirring at 25° C. and a shear rate of 1/s is 1 Pa·s or more and 100 Pa·s or less.

12. The manufacturing method of an electrostatic charge image developing toner according to claim 1,
wherein in the first aggregation, the aggregation temperature is equal to or higher than (the glass transition temperature of the resin particles for a core−15° C.) and equal to or lower than (the glass transition temperature of the resin particles for a core−3° C.).

13. The manufacturing method of an electrostatic charge image developing toner according to claim 1,
wherein in the second aggregation, the aggregation temperature is equal to or higher than (the glass transition temperature of the resin particles for a shell−40° C.) and equal to or lower than (the glass transition temperature of the resin particles for a shell−3° C.).

14. The manufacturing method of an electrostatic charge image developing toner according to claim 1,
wherein the raw material dispersion A for a core is obtained using a resin particle dispersion for a core containing the resin particles for a core, the nonionic surfactant, and the aqueous medium.

15. The manufacturing method of an electrostatic charge image developing toner according to claim 1,
wherein in the coalescence, the aggregated core particles with a shell are coalesced until an internal porosity of obtained toner particles is 5% or less.

16. The manufacturing method of an electrostatic charge image developing toner according to claim 1,
wherein in the coalescence, the coalescence temperature is 75° C. or higher and 100° C. or lower.

17. The manufacturing method of an electrostatic charge image developing toner according to claim 4,
wherein in the coalescence, the coalescence temperature is 75° C. or higher and 100° C. or lower.

18. The manufacturing method of an electrostatic charge image developing toner according to claim 8,
wherein in the first aggregation, the resin particles for a core are aggregated in a state where the raw material dispersion B for a core is being stirred at a stirring power consumption of 0.01 kW/m³ or more and 9.0 kW/m³ or less per unit volume of the raw material dispersion B for a core to which the ionic compound having a monovalent cation is added.

19. The manufacturing method of an electrostatic charge image developing toner according to claim 10,
wherein a viscosity of the raw material dispersion B for a core, to which the ionic compound having a monovalent cation is added, at 25° C. and a shear rate of 1/s is 1 Pa·s or more and 100 Pa·s or less.

20. The manufacturing method of an electrostatic charge image developing toner according to claim 15,
wherein in the coalescence, the coalescence temperature is 75° C. or higher and 100° C. or lower.
